(19) United States
(12) Patent Application Publication
(10) Pub. No.: US 2012/0185772 A1
(43) Pub. Date: Jul. 19, 2012

(54) SYSTEM AND METHOD FOR VIDEO GENERATION

(76) Inventors: Christopher Alexis Kotelly, Boston, MA (US); Christopher David Roby, Seattle, WA (US)

(21) Appl. No.: 13/354,074

(22) Filed: Jan. 19, 2012

Related U.S. Application Data
(60) Provisional application No. 61/434,141, filed on Jan. 19, 2011.

(51) Int. Cl. G06F 3/00

(52) U.S. Cl. 715/719

(57) ABSTRACT

A method, computer program product, and system for producing video presentations is provided. The method may include providing, using one or more computing devices, a template configured to enable the generation of a video presentation. The method may further include receiving, using the one or more computing devices, an input parameter associated with the template from a user. The method may also include generating instructions, using the one or more computing devices, the instructions configured to enable the video presentation based upon, at least in part, the input parameter associated with the template. The method may additionally include transmitting, using the one or more computing devices, the instructions associated with the video presentation to a video player configured to translate the video presentation to a web browser.

### CROSS-REFERENCE TO RELATED APPLICATION(S)

This application claims the benefit of U.S. Provisional Ser. No. 61/434,141, filed Jan. 19, 2011, of which the entire contents are incorporated herein by reference.

### BACKGROUND OF THE INVENTION

Current presentation technologies, including slide-show creation, video editing and production technologies require that a user construct the flow and organization of the presentation as well as add and format images, videos and text. In addition, for a user to view or experience the presentation, each of those technologies create an asset that requires the user to publish a file for viewing that either requires using a proprietary viewer, or to stream large non interactive media files via the internet on to a web browser.

Unfortunately, these tools are limited since they do not prohibit users from making complicated and long presentations, do not aid the user to employ successful methods that are used to educate and entertain, and require the user to determine how all the elements of the interactive and non-interactive presentations will be presented. Other existing tools are hard to use effectively without prior training and education.

Additionally, many other presentation technologies publish their assets to the Internet for live viewing on a computer, phone, tablet or other browser by users who are located remotely from the originating user. The result is either a file that requires proprietary software to decode the file, or a very large stream of video data, which is generally non interactive.

### BRIEF SUMMARY OF THE INVENTION

In a first embodiment, a method for producing video presentations may include providing, using one or more computing devices, a template configured to enable the generation of a video presentation. The method may further include receiving, using the one or more computing devices, an input parameter associated with the template from a user. The method may also include generating instructions, using the one or more computing devices, the instructions configured to enable the video presentation based upon, at least in part, the input parameter associated with the template. The method may additionally include transmitting, using the one or more computing devices, the instructions associated with the video presentation to a video player configured to translate the video presentation to a web browser.

One or more of the following features may be included. The video presentation may utilize, at least in part, HTML5. In some embodiments, the input parameter may include at least one of pre-recorded spoken audio, non-speech pre-recorded audio, text-to-speech audio, text, digital images, and digital video. The video presentation may be at least one of an interactive video presentation and a non-interactive video presentation. The template may be associated with at least one of the following areas, instructions for how to use a device, human-resources information, sales pitches, health care information, entertainment, financial services, corporate uses, and internet applications. In some embodiments, the template may be a pre-defined template. The template may be generated based upon, at least in part, preferences of the user. The template may include a scene editor configured to allow the user to configure one or more sections of the template. The instructions may be configured to enable time-based animation. The instructions may be generated by an engine that is indirectly coupled to the video player. The method may include automatically altering video length based upon, at least in part, a length of text obtained from the Internet. The method may further include automatically expanding video length to match audio length in a scene associated with the video presentation. The method may also include automatically contracting video length to match audio length in a scene associated with the video presentation. The method may additionally include automatically expanding audio length to match video length in a scene associated with the video presentation. The method may further include automatically contracting audio length to match video length in a scene associated with the video presentation.

In a second embodiment, a computer program product may reside on a computer readable storage medium and may have a plurality of instructions stored on it. When executed by a processor, the instructions may cause the processor to perform operations including providing, using one or more computing devices, a template configured to enable the generation of a video presentation. Operations may further include receiving, using the one or more computing devices, an input parameter associated with the template from a user. Operations may also include generating instructions, using the one or more computing devices, the instructions configured to enable the video presentation based upon, at least in part, the input parameter associated with the template. Operations may further include transmitting, using the one or more computing devices, the instructions associated with the video presentation to a video player configured to translate the video presentation to a web browser.

One or more of the following features may be included. The video presentation may utilize, at least in part, HTML5. In some embodiments, the input parameter may include at least one of pre-recorded spoken audio, non-speech pre-recorded audio, text-to-speech audio, text, digital images, and digital video. The video presentation may be at least one of an interactive video presentation and a non-interactive video presentation. The template may be associated with at least one of the following areas, instructions for how to use a device, human-resources information, sales pitches, health care information, entertainment, financial services, corporate uses, and internet applications. In some embodiments, the template may be a pre-defined template. The template may be generated based upon, at least in part, preferences of the user. The template may include a scene editor configured to allow the user to configure one or more sections of the template. The instructions may be configured to enable time-based animation. The instructions may be generated by an engine that is indirectly coupled to the video player. Operations may further include automatically altering video length based upon, at least in part, a length of text obtained from the Internet. Operations may further include automatically expanding video length to match audio length in a scene associated with the video presentation. Operations may also include automatically contracting video length to match audio length in a scene associated with the video presentation. Operations may additionally include automatically expanding audio length to match video length in a scene associated with the video presentation. Operations may further include automatically contracting audio length to match video length in a scene associated with the video presentation.

In a third embodiment, a computing system is provided. The computing system may include at least one processor and at least one memory architecture coupled with the at least one processor. The computing system may also include a first software module executable by the at least one processor and the at least one memory architecture, wherein the first software module may be configured to provide a template configured to enable the generation of a video presentation. The computing system may further include a second software module executable by the at least one processor and the at least one memory architecture, wherein the second software module is configured to receive an input parameter associated with the template from a user. The computing system may also include a third software module executable by the at least one processor and the at least one memory architecture, wherein the third software module is configured to generate instructions, the instructions configured to enable the video presentation based upon, at least in part, the input parameter associated with the template. The computing system may also include a fourth software module executable by the at least one processor and the at least one memory architecture, wherein the fourth software module is configured to transmit the instructions associated with the video presentation to a video player configured to translate the video presentation to a web browser.

One or more of the following features may be included. The video presentation may utilize, at least in part, HTML5. In some embodiments, the input parameter may include at least one of pre-recorded spoken audio, non-speech pre-recorded audio, text-to-speech audio, text, digital images, and digital video. The video presentation may be at least one of an interactive video presentation and a non-interactive video presentation. The template may be associated with at least one of the following areas, instructions for how to use a device, human-resources information, sales pitches, health care information, entertainment, financial services, corporate uses, and internet applications. In some embodiments, the template may be a pre-defined template. The template may be generated based upon, at least in part, preferences of the user. The template may include a scene editor configured to allow the user to configure one or more sections of the template. The instructions may be configured to enable time-based animation. The instructions may be generated by an engine that is indirectly coupled to the video player. The system may be configured to automatically alter video length based upon, at least in part, a length of text obtained from the Internet.

The computing system may include a fifth software module which may be configured to automatically expand video length to match audio length in a scene associated with the video presentation. The computing system may include a sixth software module which may be configured to automatically contract video length to match audio length in a scene associated with the video presentation. The computing system may include a seventh software module which may be configured to automatically expand audio length to match video length in a scene associated with the video presentation. The computing system may include a eighth software module which may be configured to automatically contract audio length to match video length in a scene associated with the video presentation.

The details of one or more implementations are set forth in the accompanying drawings and the description below. Other features and advantages will become apparent from the description, the drawings, and the claims.

### BRIEF DESCRIPTION OF THE SEVERAL VIEWS OF THE DRAWINGS

FIG. 1 is a diagrammatic view of a video generation process coupled to a computing network;

FIG. 2 is a flowchart of the video generation process of FIG. 1;

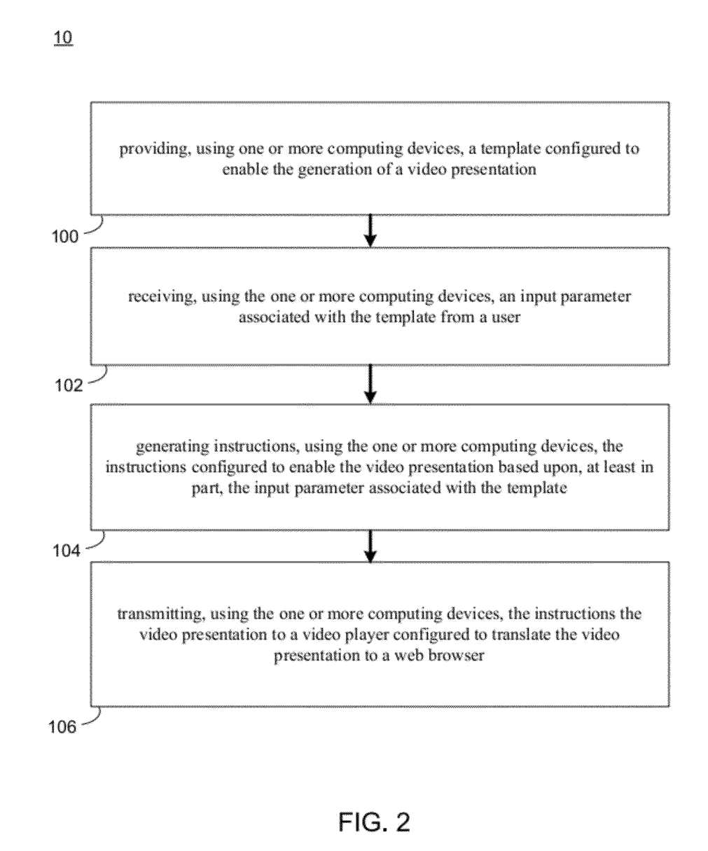

FIG. 3 an example graphical user interface which may be associated with the video generation process of FIG. 1;

FIG. 4 is also an example graphical user interface which may be associated with the video generation process of FIG. 1;

FIG. 5 is also an example graphical user interface which may be associated with the video generation process of FIG. 1;

FIG. 6 is also an example graphical user interface which may be associated with the video generation process of FIG. 1;

FIG. 7 is also an example graphical user interface which may be associated with the video generation process of FIG. 1;

FIG. 8 is also an example graphical user interface which may be associated with the video generation process of FIG. 1;

FIG. 9 is also an example graphical user interface which may be associated with the video generation process of FIG. 1;

FIG. 10 an example graphical user interface which may be associated with the video generation process of FIG. 1;

FIG. 11 is also an example graphical user interface which may be associated with the video generation process of FIG. 1;

FIG. 12 is also an example graphical user interface which may be associated with the video generation process of FIG. 1;

FIG. 13 is also an example graphical user interface which may be associated with the video generation process of FIG. 1;

FIG. 14 is also an example graphical user interface which may be associated with the video generation process of FIG. 1;

FIG. 15 is also an example graphical user interface which may be associated with the video generation process of FIG. 1;

FIG. 16 is also an example graphical user interface which may be associated with the video generation process of FIG. 1;

FIG. 17 an example graphical user interface which may be associated with the video generation process of FIG. 1;

FIG. 18 is also an example graphical user interface which may be associated with the video generation process of FIG. 1;

FIG. 19 is also an example graphical user interface which may be associated with the video generation process of FIG. 1;

FIG. 20 is also an example graphical user interface which may be associated with the video generation process of FIG. 1;

FIG. 21 is also an example graphical user interface which may be associated with the video generation process of FIG. 1;

FIG. 22 is also an example graphical user interface which may be associated with the video generation process of FIG. 1;

FIG. 23 is also an example graphical user interface which may be associated with the video generation process of FIG. 1;

FIG. 24 an example graphical user interface which may be associated with the video generation process of FIG. 1;

FIG. 25 is also an example graphical user interface which may be associated with the video generation process of FIG. 1;

FIG. 26 is also an example graphical user interface which may be associated with the video generation process of FIG. 1;

FIG. 27 is also an example graphical user interface which may be associated with the video generation process of FIG. 1;

FIG. 28 is also an example graphical user interface which may be associated with the video generation process of FIG. 1;

FIG. 29 is also an example graphical user interface which may be associated with the video generation process of FIG. 1;

FIG. 30 an example graphical user interface which may be associated with the video generation process of FIG. 1;

FIG. 31 an example graphical user interface which may be associated with the video generation process of FIG. 1;

FIG. 32 is also an example graphical user interface which may be associated with the video generation process of FIG. 1;

FIG. 33 is also an example graphical user interface which may be associated with the video generation process of FIG. 1;

FIG. 34 is also an example graphical user interface which may be associated with the video generation process of FIG. 1;

FIG. 35 is also an example graphical user interface which may be associated with the video generation process of FIG. 1;

FIG. 36 is also an example graphical user interface which may be associated with the video generation process of FIG. 1;

FIG. 37 is also an example graphical user interface which may be associated with the video generation process of FIG. 1;

FIG. 38 an example graphical user interface which may be associated with the video generation process of FIG. 1;

FIG. 39 is also an example graphical user interface which may be associated with the video generation process of FIG. 1;

FIG. 40 is also an example graphical user interface which may be associated with the video generation process of FIG. 1;

FIG. 41 is also an example graphical user interface which may be associated with the video generation process of FIG. 1;

FIG. 42 is also an example graphical user interface which may be associated with the video generation process of FIG. 1;

FIG. 43 is also an example graphical user interface which may be associated with the video generation process of FIG. 1;

FIG. 44 is also an example graphical user interface which may be associated with the video generation process of FIG. 1;

FIG. 45 an example graphical user interface which may be associated with the video generation process of FIG. 1;

FIG. 46 is also an example graphical user interface which may be associated with the video generation process of FIG. 1;

FIG. 47 is also an example graphical user interface which may be associated with the video generation process of FIG. 1;

FIG. 48 is also an example graphical user interface which may be associated with the video generation process of FIG. 1;

FIG. 49 is also an example graphical user interface which may be associated with the video generation process of FIG. 1;

FIG. 50 is also an example graphical user interface which may be associated with the video generation process of FIG. 1;

FIG. 51 is also an example graphical user interface which may be associated with the video generation process of FIG. 1;

FIG. 52 an example graphical user interface which may be associated with the video generation process of FIG. 1;

FIG. 53 is also an example graphical user interface which may be associated with the video generation process of FIG. 1;

FIG. 54 is also an example graphical user interface which may be associated with the video generation process of FIG. 1;

FIG. 55 is also an example graphical user interface which may be associated with the video generation process of FIG. 1;

FIG. 56 is also an example graphical user interface which may be associated with the video generation process of FIG. 1;

FIG. 57 is also an example graphical user interface which may be associated with the video generation process of FIG. 1;

FIG. 58 is also an example graphical user interface which may be associated with the video generation process of FIG. 1;

FIG. 59 an example graphical user interface which may be associated with the video generation process of FIG. 1;

FIG. 60 is also an example graphical user interface which may be associated with the video generation process of FIG. 1;

FIG. 61 is also an example graphical user interface which may be associated with the video generation process of FIG. 1;

FIG. 62 is also an example graphical user interface which may be associated with the video generation process of FIG. 1; and

FIG. 63 is also an example graphical user interface which may be associated with the video generation process of FIG. 1.

### DETAILED DESCRIPTION OF THE INVENTION

Embodiments disclosed herein are directed towards a method, computer program product, client and server application configured to produce interactive, and non-interactive video presentations on a web browser. The system may allow users to employ templates that enable the integration of pre-recorded spoken audio, non-speech pre-recorded audio; text-to-speech synthesized audio, text, digital images, and digital video in a structured way. In some embodiments, a user may input parameters into a template that dictate the methods by which interactive and non-interactive videos are rendered. The videos may be assembled using digital images, video, pre-recorded audio, real-time generated audio, and data which is generated by the server. The data may be provided to the player which describes to a browser how to render the interactive and non-interactive video. Existing tools require a user to format all of their visual and auditory assets, whereas video generation process 10 may automate this process using knowledge about the assets and context of the presentation in order to assemble the assets into an interactive or non-interactive presentation.

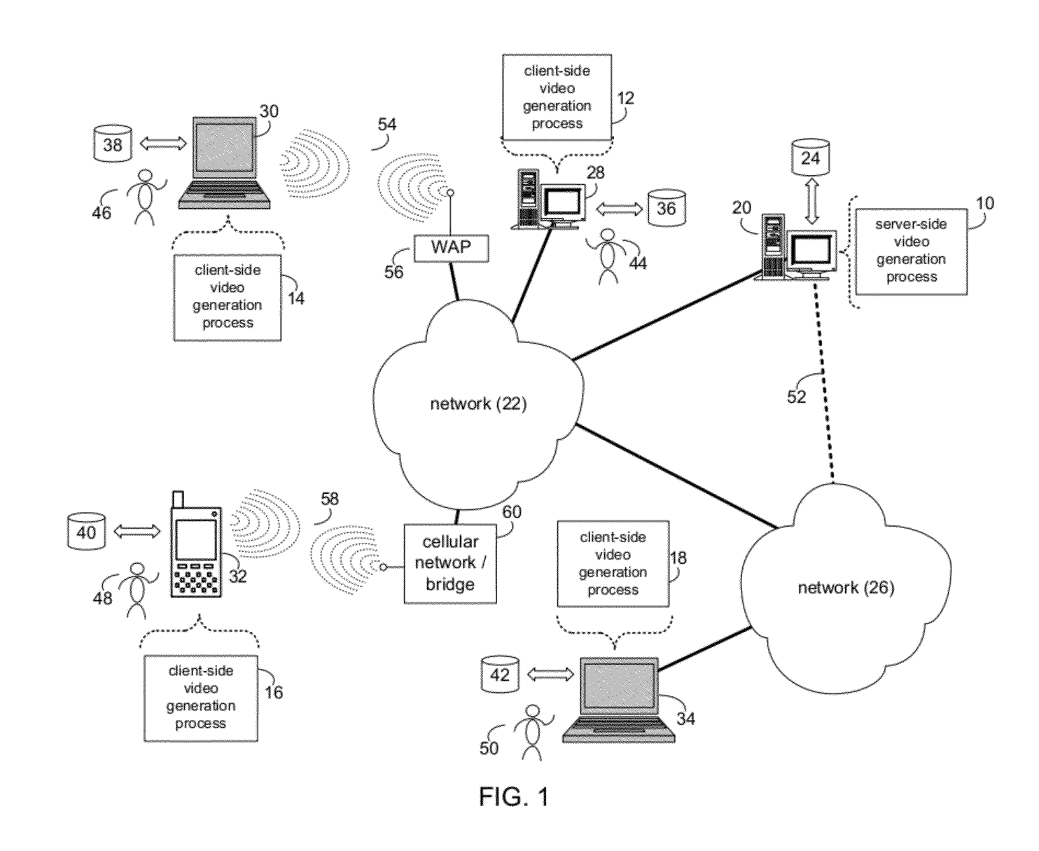

Referring to FIGS. 1 & 2, there is shown a video generation process 10. As will be discussed below, video generation process 10 may provide 100 a template configured to enable the generation of a video presentation. Video generation process 10 may receive 102 an input parameter associated with the template from a user and may generate 104 instructions, the instructions configured to enable the video presentation based upon, at least in part, the input parameter associated with the template. Video generation process 10 may transmit 106 the instructions associated with the video presentation to a video player configured to translate the video presentation to a web browser. Additionally and/or alternatively, a browser-rendering-engine may be utilized to render the video before sending it to other video platforms.

The video generation process may be a server-side process (e.g., server-side video generation process 10), a client-side process (e.g., client-side video generation process 12, client-side video generation process 14, client-side video generation process 16, or client-side video generation process 18), or a hybrid server-side/client-side process (e.g., the combination of server-side video generation process 10 and one or more of client-side video generation processes 12, 14, 16, 18).

Server-side video generation process 10 may reside on and may be executed by server computer 20, which may be connected to network 22 (e.g., the Internet or a local area network). Examples of server computer 20 may include, but are not limited to: a personal computer, a server computer, a series of server computers, a mini computer, and/or a mainframe computer. Server computer 20 may be a web server (or a series of servers) running a network operating system, examples of which may include but are not limited to: Microsoft Windows Server; Novell Netware; or Red Hat Linux, for example.

The instruction sets and subroutines of server-side video generation process 10, which may be stored on storage device 24 coupled to server computer 20, may be executed by one or more processors (not shown) and one or more memory architectures (not shown) incorporated into server computer 20. Storage device 24 may include but is not limited to: a hard disk drive; a tape drive; an optical drive; a RAID array; a random access memory (RAM); and a read-only memory (ROM).

Server computer 20 may execute a web server application, examples of which may include but are not limited to: Microsoft IIS, Novell Web Server, or Apache Web Server, that allows for access to server computer 20 (via network 22) using one or more protocols, examples of which may include but are not limited to HTTP (i.e., HyperText Transfer Protocol), SIP (i.e., session initiation protocol), and the Lotus® Sametime® VP protocol. Network 22 may be connected to one or more secondary networks (e.g., network 26), examples of which may include but are not limited to: a local area network; a wide area network; or an intranet, for example.

Client-side video generation processes 12, 14, 16, 18 may reside on and may be executed by client electronic devices 28, 30, 32, and/or 34 (respectively), examples of which may include but are not limited to personal computer 28, laptop computer 30, a data-enabled mobile telephone 32, notebook computer 34, personal digital assistant (not shown), smart phone (not shown) and a dedicated network device (not shown), for example. Client electronic devices 28, 30, 32, 34 may each be coupled to network 22 and/or network 26 and may each execute an operating system, examples of which may include but are not limited to Microsoft Windows, Microsoft Windows CE, Red Hat Linux, or a custom operating system.

The instruction sets and subroutines of client-side video generation processes 12, 14, 16, 18, which may be stored on storage devices 36, 38, 40, 42 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Storage devices 36, 38, 40, 42 may include but are not limited to: hard disk drives; tape drives; optical drives; RAID arrays; random access memories (RAM); read-only memories (ROM); compact flash (CF) storage devices; secure digital (SD) storage devices; and memory stick storage devices.

Client-side video generation processes 12, 14, 16, 18 and/or server-side video generation process 10 may be processes that run within (i.e., are part of) a unified communications and collaboration application configured for unified telephony and/or VoIP conferencing (e.g., Lotus® Sametime®). Alternatively, client-side video generation processes 12, 14, 16, 18 and/or server-side video generation process 10 may be stand-alone applications that work in conjunction with the unified communications and collaboration application application. One or more of client-side video generation processes 12, 14, 16, 18 and server-side video generation process 10 may interface with each other (via network 22 and/or network 26). The unified communications and collaboration application may be a unified telephony application and/or a VoIP conferencing application. Video generation process 10 may also run within any e-meeting application, web-conferencing application, or teleconferencing application configured for handling IP telephony and/or VoIP conferencing.

Users 44, 46, 48, 50 may access server-side video generation process 10 directly through the device on which the client-side video generation process (e.g., client-side video generation processes 12, 14, 16, 18) is executed, namely client electronic devices 28, 30, 32, 34, for example. Users 44, 46, 48, 50 may access server-side video generation process 10 directly through network 22 and/or through secondary network 26. Further, server computer 20 (i.e., the computer that executes server-side video generation process 10) may be connected to network 22 through secondary network 26, as illustrated with phantom link line 52.

The various client electronic devices may be directly or indirectly coupled to network 22 (or network 26). For example, personal computer 28 is shown directly coupled to network 22 via a hardwired network connection. Further, notebook computer 34 is shown directly coupled to network 26 via a hardwired network connection. Laptop computer 30 is shown wirelessly coupled to network 22 via wireless communication channel 54 established between laptop computer 30 and wireless access point (i.e., WAP) 56, which is shown directly coupled to network 22. WAP 56 may be, for example, an IEEE 802.11a, 802.11b, 802.11g, 802.11n, Wi-Fi, and/or Bluetooth device that is capable of establishing wireless communication channel 54 between laptop computer 30 and WAP 56. Data-enabled mobile telephone 32 is shown wirelessly coupled to network 22 via wireless communication channel 58 established between data-enabled mobile telephone 32 and cellular network/bridge 60, which is shown directly coupled to network 22.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

### The Video Generation Process

For the following discussion, server-side video generation process 10 will be described for illustrative purposes. It should be noted that client-side video generation process 12 may interact with server-side video generation process 10 and may be executed within one or more applications that allow for communication with client-side video generation process 12. However, this is not intended to be a limitation of this disclosure, as other configurations are possible (e.g., stand-alone, client-side video generation processes and/or stand-alone server-side video generation processes.) For example, some implementations may include one or more of client-side video generation processes 12, 14, 16, 18 in place of or in addition to server-side video generation process 10.

Embodiments disclosed herein relate to the creation of interactive and non-interactive presentations and videos assembled using templates. More specifically, the present disclosure relates to a system and method of using flexible video templates to allow users to quickly insert text, choose photos from a library, and/or upload images/videos, then publish a dynamic video-experience with pre-recorded audio, text-to-speech audio, and non-speech audio icons and music.

Embodiments disclosed herein may be applied in any number of applications. Some of these may include, but are not limited to, product launch videos, videos that welcome someone to a company, videos to run during a conference—taking weeks of budget allocation, script writing, video production, internal reviews, publishing, etc. These types of videos may be produced by the user in a few hours (or as quick as a few minutes), using a standard computing device with a browser, with templates that may employ strong didactic techniques. Embodiments described herein may also allow for the integration of live data and may not require large amounts of bandwidth for streaming (e.g., in some embodiments HTML5 may be utilized for most of the content delivery).

In some embodiments, video generation process 10 may utilize HTML5 in whole or in part. As HTML5 is adopted by all web browsers, the standards emerging from it may include three-dimensional rendering, video without plug-ins, video transition techniques, text rendering engines (in which the text is still searchable and crawlable by web-crawlers), and synchronization between audio, video in any open window. Accordingly, there now exists the ability for light-weight videos (e.g., 5 meg, instead of the typical YouTube 45 meg) to create compelling experiences that educate and entertain.

Embodiments described herein may allow users to create video-experiences with flexible templates. These templates may allow users to obtain access to voice recordings from professional voice talents, professionally produced images and stunning transitions, while ensuring an impactful viewing experience by leveraging real-time information which may be received and rendered at the time the video is viewed (e.g., map, traffic, Facebook and Twitter updates, etc.). In some embodiments, the user may even add their own images, video and text. And best of all, using the video generation process described herein, this content may be contained in a way so the typical user can't break the short, well-structured video. In this way, video generation process 10 may allow bloggers, and corporate users to construct video-experiences that may be distributed by email, placed on web sites, and integrated with other services such as Constant-Contact, Facebook, and more.

The term “template” as used herein may refer to a data structure that may be generated by one or more users and may specify the flow of how the interactive or non-interactive video will progress. In this way, a template may be a dynamic storyboard, that may allow a user to select various pre-recorded wording, insert their own text, choose images, etc. The user may preview their interactive or non-interactive video.

In some embodiments, video generation process 10 may employ a series of templates broken into several categories, and a toolbox may allow users to create their own variations of templates (e.g., with a revenue share model for user-developers who create templates others employ). Additionally and/or alternatively, users may be charged according to the number of videos they make and the number of expected views. Further, an analytics package may be deployed to help people analyze the views of the video-experiences they create. In this way, video generation process 10 may allow someone to quickly check off the areas of the template they want to use, fill out a few text forms, select stock images, upload an image from their camera-phone, and publish the video for viewing.

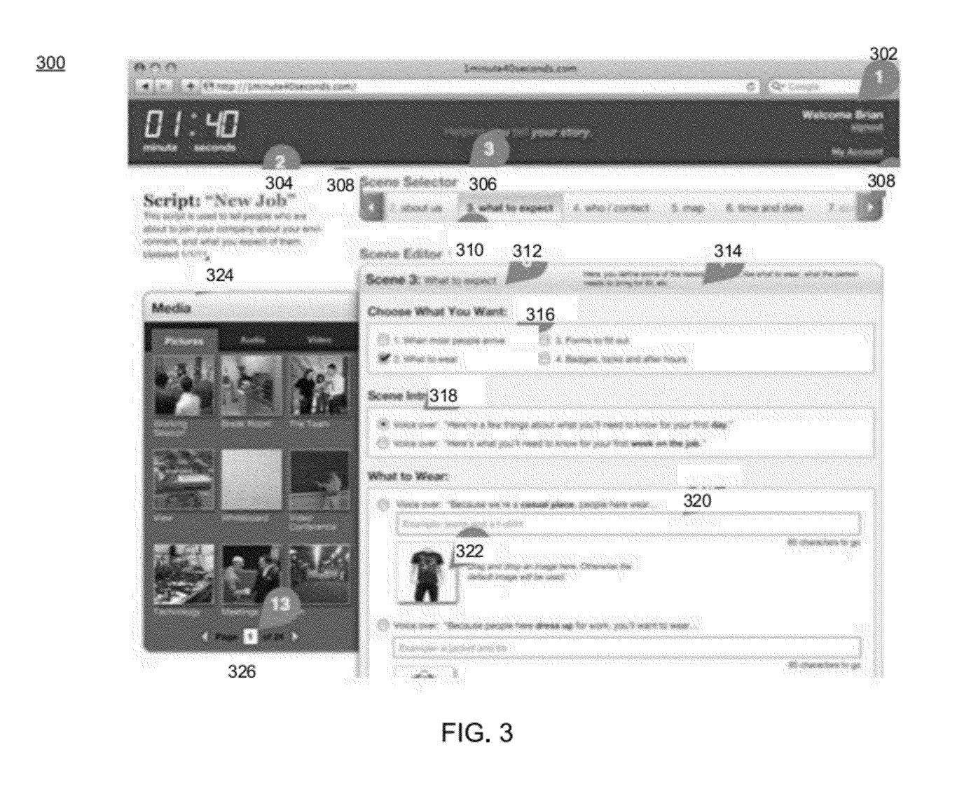

Referring to FIG. 3, one embodiment of a video generation template 300 is provided. In this particular example, a user (e.g., one or more of users 44, 46, 48, and 50) may have signed up for an account 302 and in doing so would receive the benefit of being able to access assets that they have previously uploaded to the site (e.g. pictures, audio, video, etc.) through media browser 324 and media browser navigator 326. Additionally and/or alternatively, these assets may have been provided by another party. In this way, the user may then select a template 304 from a set of templates that are either pre-defined or created by other users who would have access to a toolkit that enables the creation of new templates. In some embodiments, these templates may pertain to any number of topics, including, but not limited to, instructions for how to use a device, human-resources information, sales pitches, health-care information, entertainment, etc. Accordingly, a user may input text in text boxes that may limit the length of the input as per the parameter of the template 320 or point to other media such as still images, audio or video 322.

In some embodiments, a user (e.g., one or more of users 44, 46, 48, and 50) may select a scene within a template 306 and by using controls that may include sliders, arrows, or other methods of navigating 308 through a set of sections that have been associated with a particular template. Template 300 may further include scene editor 310, which may be configured to allow the user to input details of a particular section of template 300. Scene editor 310 may be flexible and may be dynamically generated when the user selects the section of the template upon which to work. This may allow a person who manages a template or an automated system that manages the template to update elements of the template at any time, and those changes may then be reflected in the user experience of someone who selects that template. For example, as soon as the changes have been saved by the server and then viewed by the user.

Embodiments disclosed herein may allow one or more users to create new templates to suit specific needs. A core set of templates may help companies and/or individuals produce interactive and non-interactive videos for any suitable topic. Some of these may include, but are not limited to, human resources (e.g., hiring, loss of job, employee education, etc.), financial services (e.g., earning calls, market updates to clients, etc.), health care (e.g., pre- and post-operative care instructions, physical therapy instructions, rehabilitation instructions, operation of medical devices, etc.), product companies (e.g., instructions for the operation of a device or application, the assembly of a device or application, the use of a device or application, etc.), corporate uses (e.g., employee training, employee education, product announcements, sales applications, marketing applications, etc.), internet applications (e.g., restaurant reviews, product reviews, etc.). It should be noted that these examples are merely provided by way of example, as the video generation process described herein may be used in any suitable application.

In some embodiments, a template (e.g. template 300) may exist in a data structure that describes to the server-side application how to render the view of the template to the user as shown in FIG. 3. In this way, a template may allow a user (e.g., one or more of users 44, 46, 48, and 50) to select pre-recorded audio 318 or input their own text 320, which may either be rendered in real-time using text-to-speech software or sent to a third party to record and re-insert the recorded audio, or use uploaded audio provided by the user or by another party. Templates may allow a user to select media from such things as a media browser 324 or from a search interface that could connect to another site that provides media. Templates may control how much text the user is allowed to input, how long an audio file or video file can be uploaded, or used in a specific section of a template 316 and may also allow functionality such as a trimmer that helps users trim audio or video content for use in that section. Additionally and/or alternatively, templates may be configured to capture specific key-variables that may be automatically used in other sections of the template or other templates by that same user or by another user within a group of users. Such variables may include static elements, such as the name of a company, which may be captured in one form, then used in several parts of the template and automatically populated. Variables may also include dynamic elements such as today's date, a relative date, a live feed of data from an online source, or any other type of dynamically changing information.

Embodiments of the video generation process described herein may also include the ability for a user to select a media file such as an image, mark locations on the image and mark corresponding words or letters in a text field that is either pre-populated or entered by the user. A template (e.g. template 300) may then generate an interactive and/or non-interactive video that could perform various animations such as zooming in and panning to a particular part of that image while being synchronized to the corresponding text that had been marked. In addition, a video may be marked, the frame of a video and a location on the frame of a video, and corresponding elements can be marked to be synchronized to appear at specific moments of the video, and if the user chooses and the template allows, in specific areas of the video image.

Embodiments of the video generation process described herein may also allow for closed captioning, for example, in the style that can be seen on television shows. This may be enabled if the template exposes the text, including pre-written text and text written by the user, synchronized to the video. The text may appear in the video area, or outside the video area or overlapping the video and non-video areas. This text can also be exposed to search engines in order to index the content of the interactive and non interactive-video.

In some embodiments, the video generation process described herein may also detect the browser that the user is using and control multiple browser windows if that particular user is using a device that allows for multiple windows to be used and the template elects to expose multiple windows. The multiple windows may be synchronized in order to allow another interactive or non-interactive video to play while another window appears which can have the same properties as the primary interactive or non-interactive video. This may allow for a viewer to see a video in one screen, while another screen shows instructions that can persist while the video is playing and persist when the video is over. This may allow for sales people to leave behind an image, PDF document, or other type of text, image, video or other media to be viewed by the user at a later date, as well as live data that may include maps, traffic information, stock price information or other live data.

Additionally and/or alternatively, the first interactive or non-interactive video that is displayed may be synchronized with the other interactive or non-interactive video in another window, synchronizing audio, video, and the time when the secondary video window is rendered. It should be noted that there is no limit to the number of window instantiations that may be controlled, and the primary window may also be closed and allow the other windows to persist.

In some embodiments, background music may also be played while the pre-recorded spoken audio, generated text-to-speech audio, or other audio files are playing. This background music may be synchronized to occur at any time during the playing of the interactive or non-interactive video.

In some embodiments, the video generation process and/or a template may also determine that a particular browser does not allow for certain features to be used and could allow for a unique experience for the user in the event that the browser either lacks specific features, or has additional features that can be leveraged. For example, this may include a situation where a browser doesn't display multiple windows side-by-side, as is the case for most mobile-phone browsers. The video generation process may allow for a different behavior, such as changing the video presentation to allow a user to view the information that would have been placed on another window and return to the video. Additionally and/or alternatively, the video generation process may eliminate the secondary browser window content completely, and even change the behavior of the primary interactive or non-interactive video.

In some embodiments, the video generation process described herein may allow a user to publish the interactive or non-interactive video once a user determines that they are satisfied with their project. The data that describes the video's structure may be stored on the server, and when someone wants to view the interactive or non-interactive video, they may download the data to their browser for temporary use. Some content that has been made to persist on the end-user's browser may remain after the video has completed playing while other content may not remain on the viewer's browser.

The video generation process described herein may distribute the content using any suitable approach. Some techniques may include, but are not limited to, sending a link to the site that hosts the code that renders the interactive or non-interactive video, embedding the link in an email, and integration with systems such as bulk-emailing system, or enterprise resource planning (“ERP”) systems. Accordingly, aspects of the video generation process may be provided to a number of individuals, in which each interactive or non-interactive video could be customized with information specific to that particular viewer.

In some embodiments, the video generation process described herein may provide statistics to one or more users who distribute the interactive or non-interactive video so that they may monitor viewing activity. The monitored activity may include, but is not limited to, how much of the video was viewed by a particular user, how many users viewed the video, how many times a particular user or set of users viewed the video, how many users interacted with particular sections of interactive-videos, as well as the browser and hardware technology the viewers are using to view the videos, etc.

In some embodiments, the video generation process described herein may integrate text-to-speech functionality and pre-recorded voices, and may also accommodate user-generated audio as well. The video generation process described herein may utilize time-based animation timeline, compared to frame-rate based animation. So any browser will view the video-experience the same way, at the same speed, even if the processors vary widely in speed.

As discussed above, the video generation process described herein may include both a video player and an engine. In some embodiments, the player and the engine that generates the code which is sent to the player, may not be coupled directly. In this way, the player may be configured to interpret a wide variety of data.

In some embodiments, the video generation process described herein may be configured to automatically expand or contract scene lengths. In this way, scene length may be driven by a variety of data inputs, including, but not limited to, the length of processed text-to-speech audio and/or specific animation actions. For example, if the user types in a lot of information for the system to speak, the animation may stretch to accommodate the longer spoken phrase—while a user who types in less text to be spoken, may render a video with a shorter animation length for that scene. The data-driven nature of this integration may allow for highly cohesive viewing experiences in which the length of any animation is appropriate for the spoken text. Additionally and/or alternatively, the length of the animation may be driven by other, dynamic data, such as the length of a text string being pulled off the internet in real-time (e.g., a news story, RSS headline, etc.).

Embodiments of the video generation process described herein may include one or more programs configured to generate a video-block. As used herein, the phrase “video block” may refer to a program in which media (e.g., image, text, audio, etc.) is self-describing and may indicate its own duration, movement, etc. In this way, a video-block program may have child programs, which may move and display relative to their parent program. For example, when a parent program indicates that it may move a picture 20 pixels to the right, any child program within that parent program may take on that attribute and in addition to executing its own movement, may also move 20 pixels to the right. This may occur if you have text that lives within a moving image, for example, in which the text also is animating somehow. Since the text may be a child of the moving image, it may absorb some or all the characteristics of the movement of the parent image and may also performs its own specified movement. In some embodiment, the video-experiences may be entirely data driven. In this way, there may be no video in the traditional sense (e.g. a YouTube video, etc.) since it may be rendered in real time and may utilize live data. In some embodiments, the video generation process described herein may utilize HTML5, in particular the canvas, audio, and video elements used to drive the presentation and may use the local store element as well.

In some embodiments, video generation process 10 may generate interactive or non-interactive videos. For example, the videos may play as a typical YouTube style video presentation. Additionally and/or alternatively, video generation process 10 may allow the user to input information, make selections, and/or use information that is provided through other sources, such as the user's geo-location, browser and computer specifications in order to enhance the user experience. The video may pause until an action has occurred or resume playing if no interaction has occurred.

In some embodiments, video generation process 10 may allow for file uploads using HTML5 drag and drop technology. Video generation process 10 may further include a voice recorder, for example, a licensed flash recorder, which may include a custom interface and/or playback via an HTML5 element. Video generation process 10 may also include a frontend object mapper (e.g., a small engine that may be configured to fetch the video data from a server computing device and iterates through the front-end input interface). In this way, the frontend object mapper may map the data back to each input form or template so that when a user enters the edit mode their previous work appears.

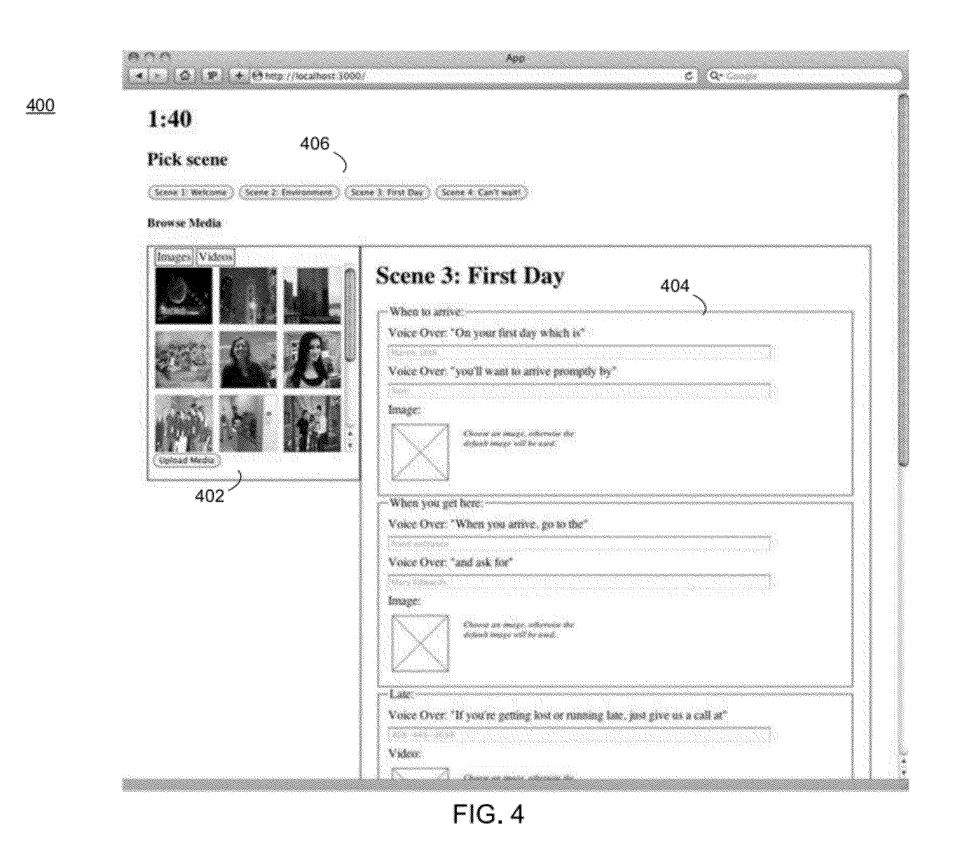

Referring now to FIG. 4, an embodiment showing a graphical user interface 400 consistent with video generation process 10 is provided. In this particular example, a template for an employee's first day at a new job is provided. In this way, graphical user interface 400 may include a variety of different components. Graphical user interface 400 may include media browser 402, which may allow a user to upload and/or preview various images, videos, etc. Graphical user interface 400 may further include template 404, which may allow a user to input text that may be converted to audio. Graphical user interface 400 may further include scene selection buttons 406, which may allow a user to select the particular scene that they would like to edit.

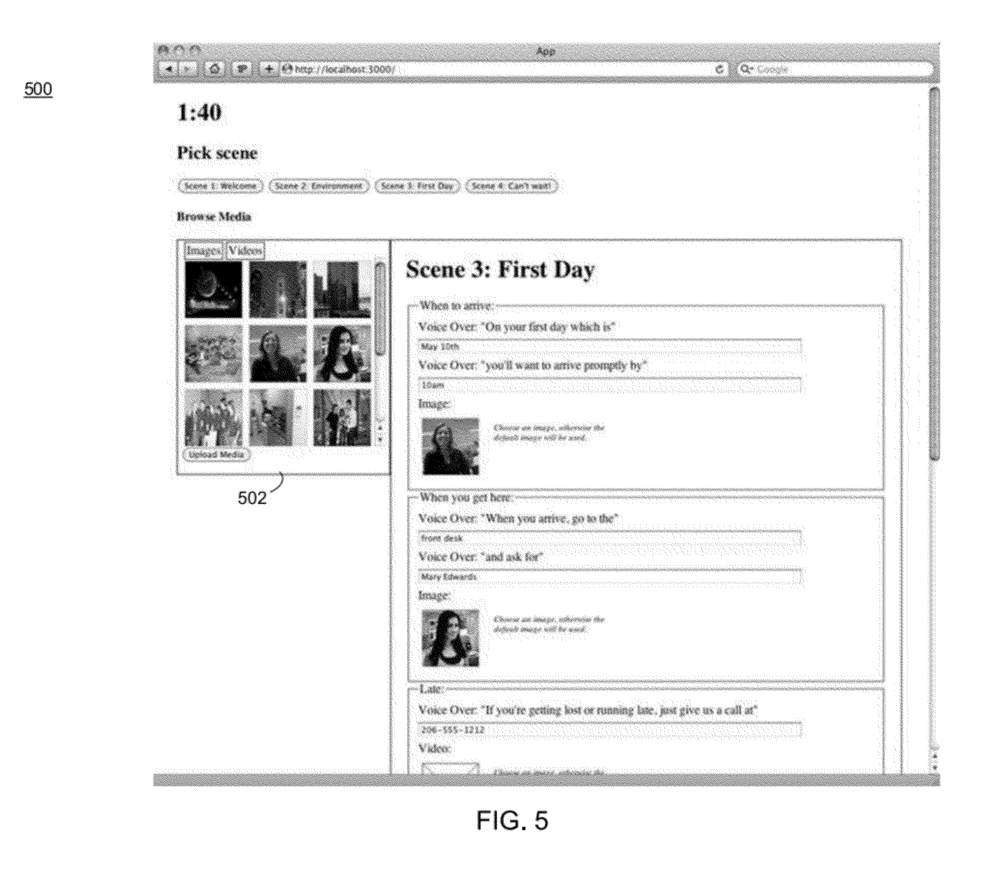

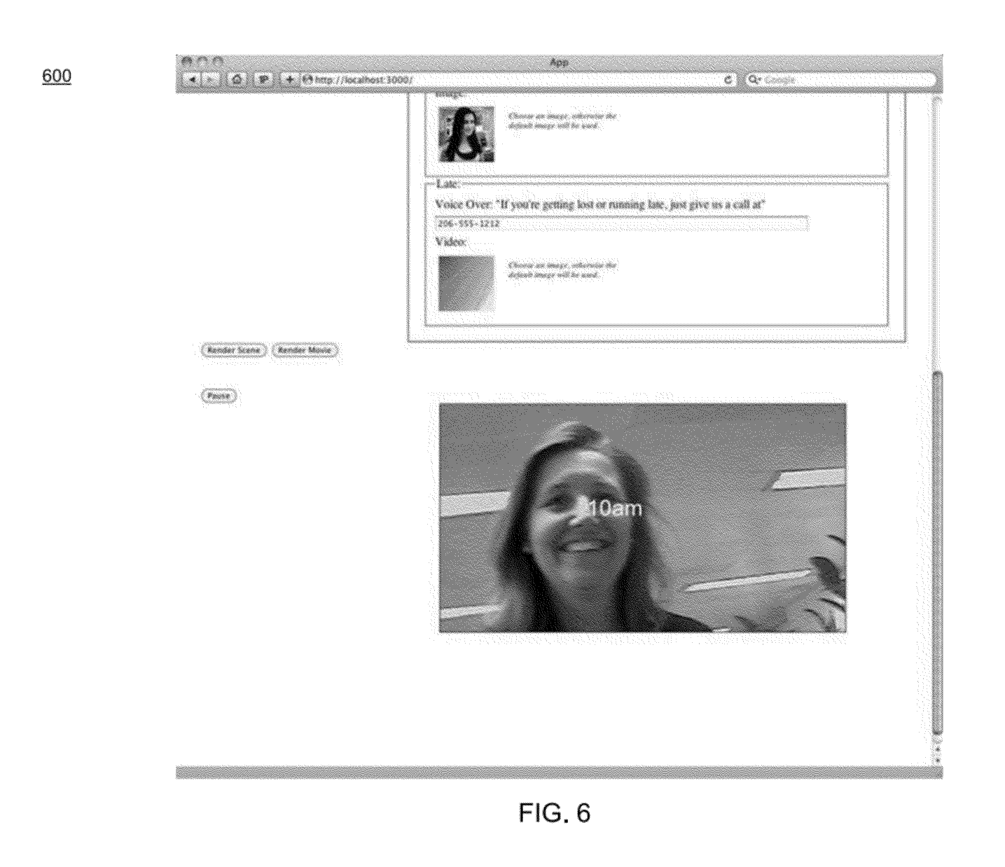

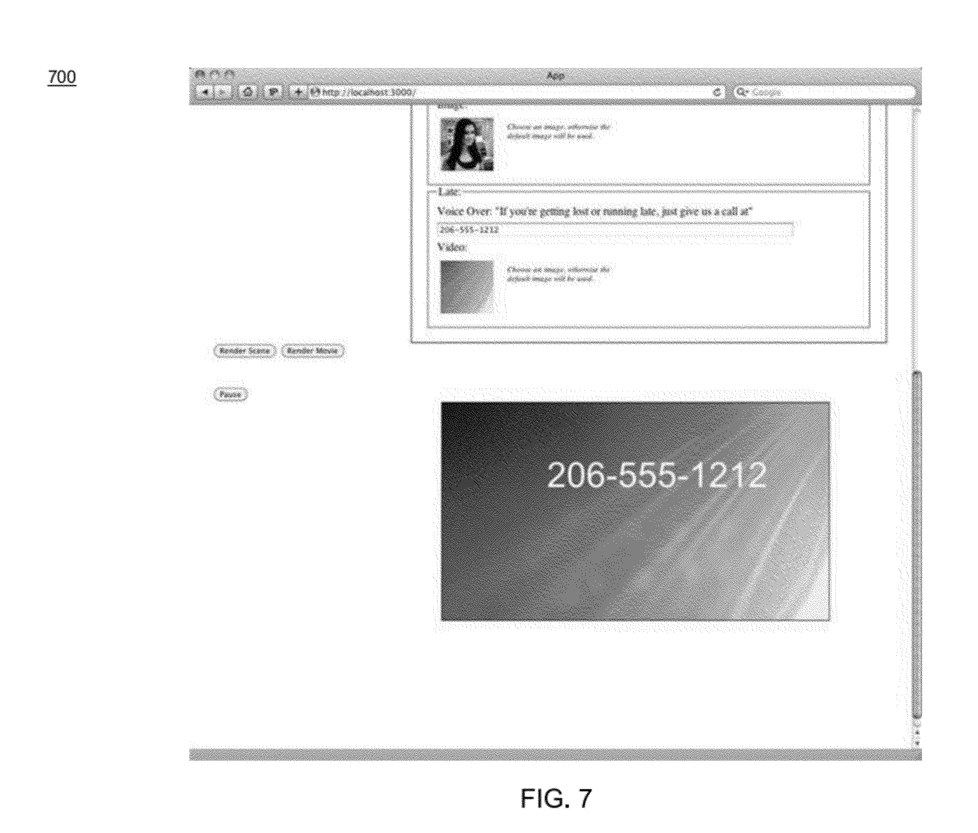

Referring now to FIGS. 5-7, embodiments showing a graphical user interface 500 consistent with video generation process 10 is provided. Graphical user interface 500 shows text and media that a user has input into the template. In some embodiments, this text may be translated by a text-to-speech engine. The images shown in FIG. 5 may have been placed in the template from media browser 402, 502. In FIG. 6, the user may have rendered the scene and may be in the process of previewing the generated video. In addition to hearing the pre-recorded text, the user may hear the text-to-speech voice saying “10 am” and the text is displayed on top of the image that was selected for this scene. In FIG. 7, the user may have rendered the scene and again may be in the process of previewing the generated video and/or scene. In addition to hearing the pre-recorded text, the user may hear the text-to-speech voice saying the phone number and the text is displayed on top of the video that was selected for this scene.

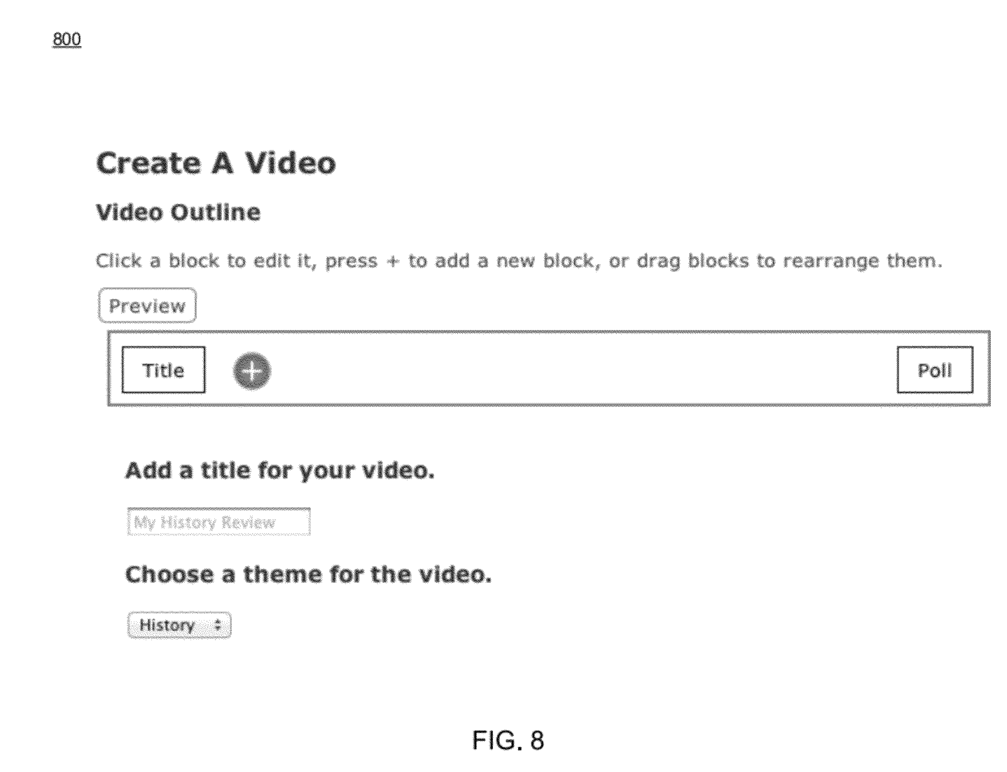

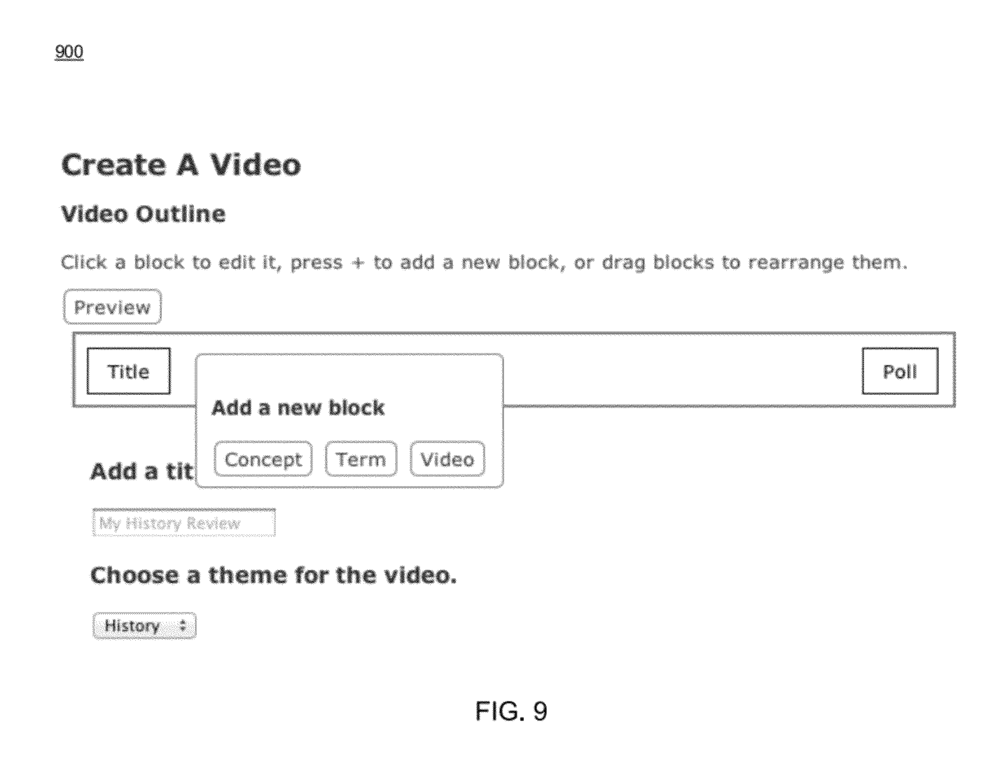

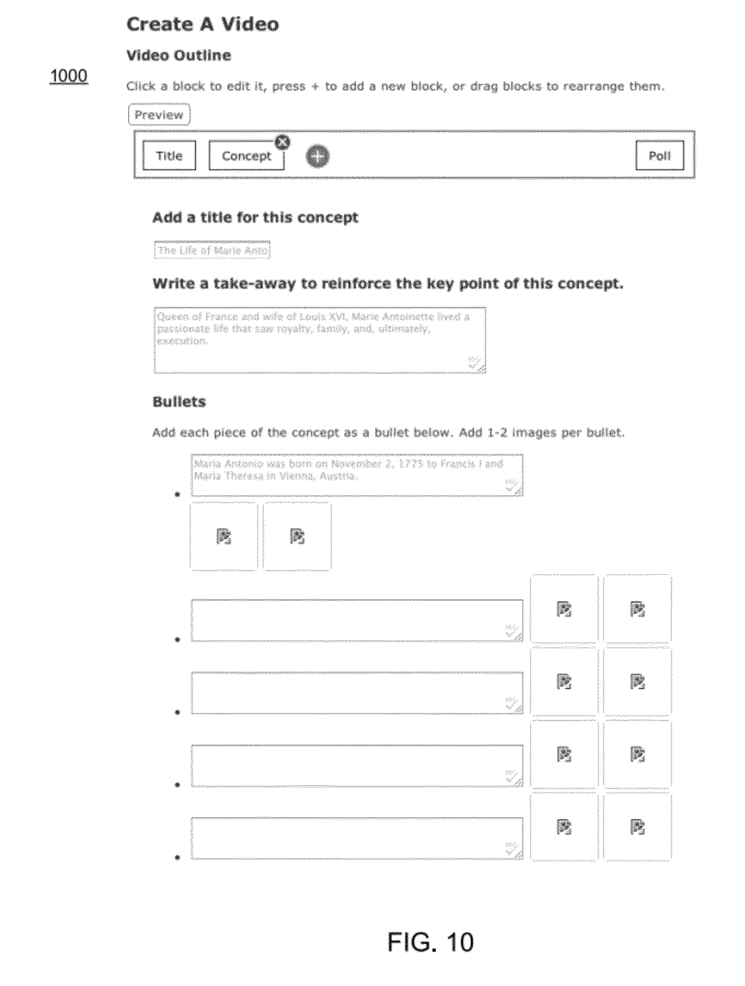

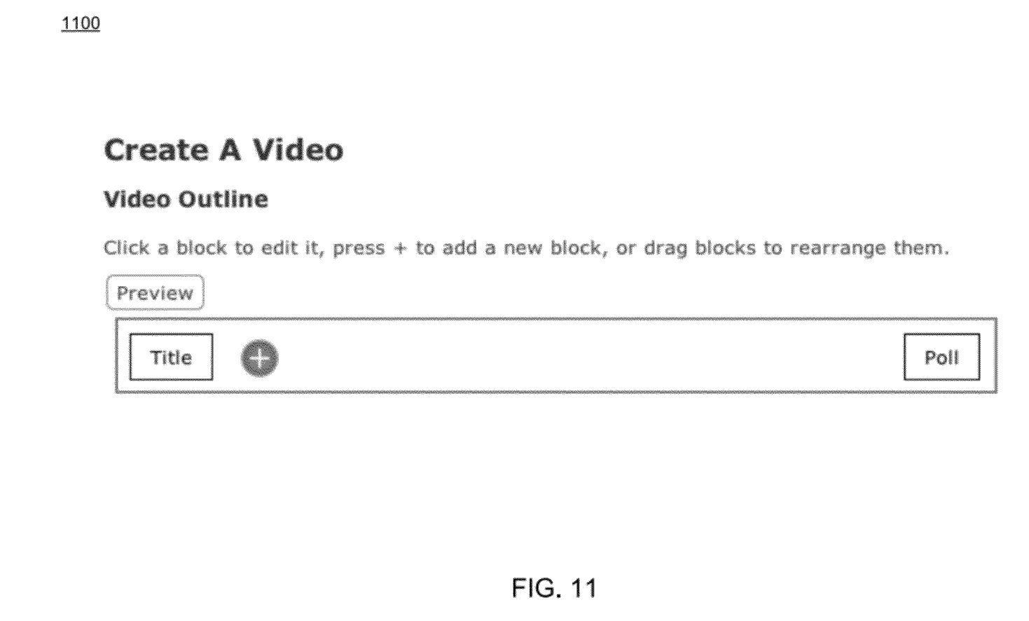

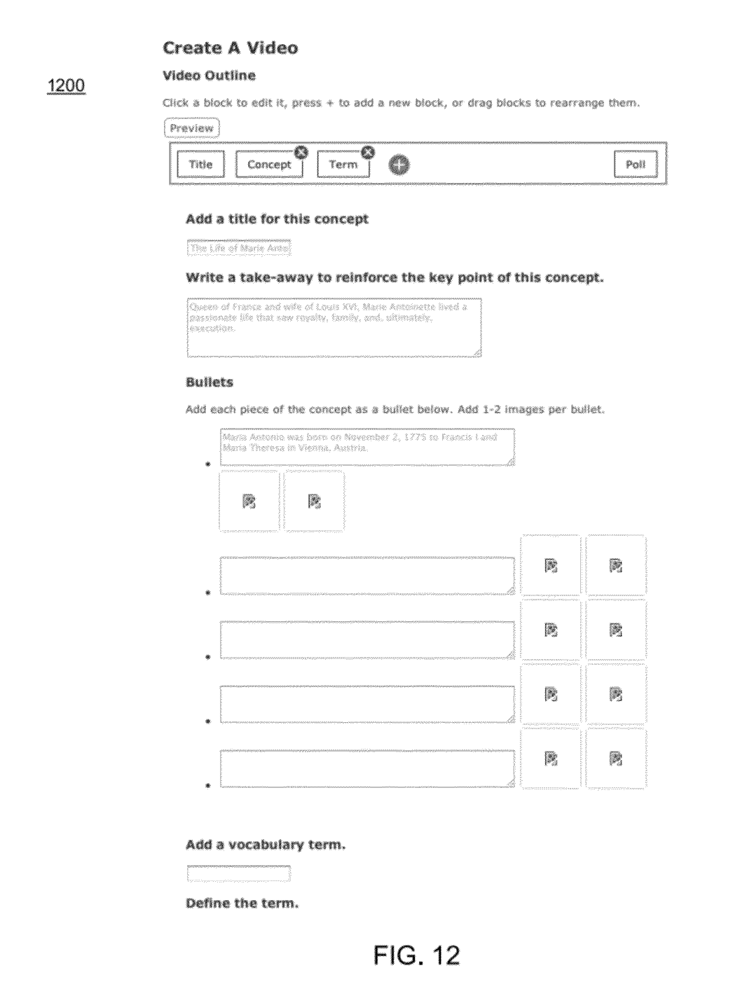

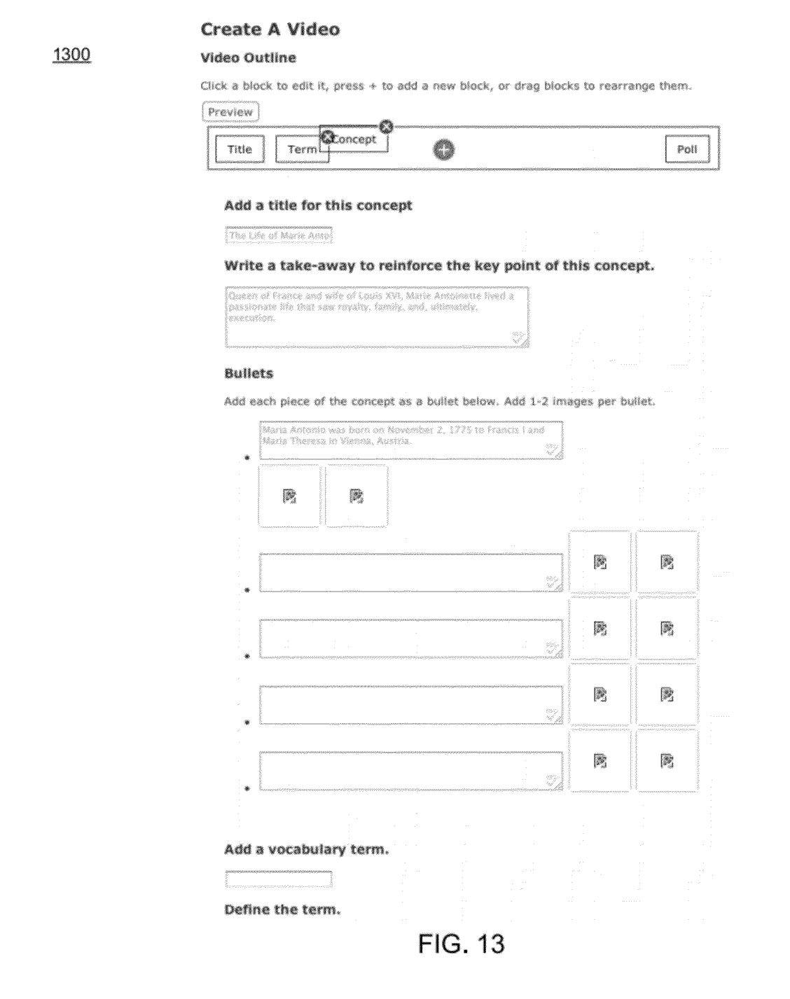

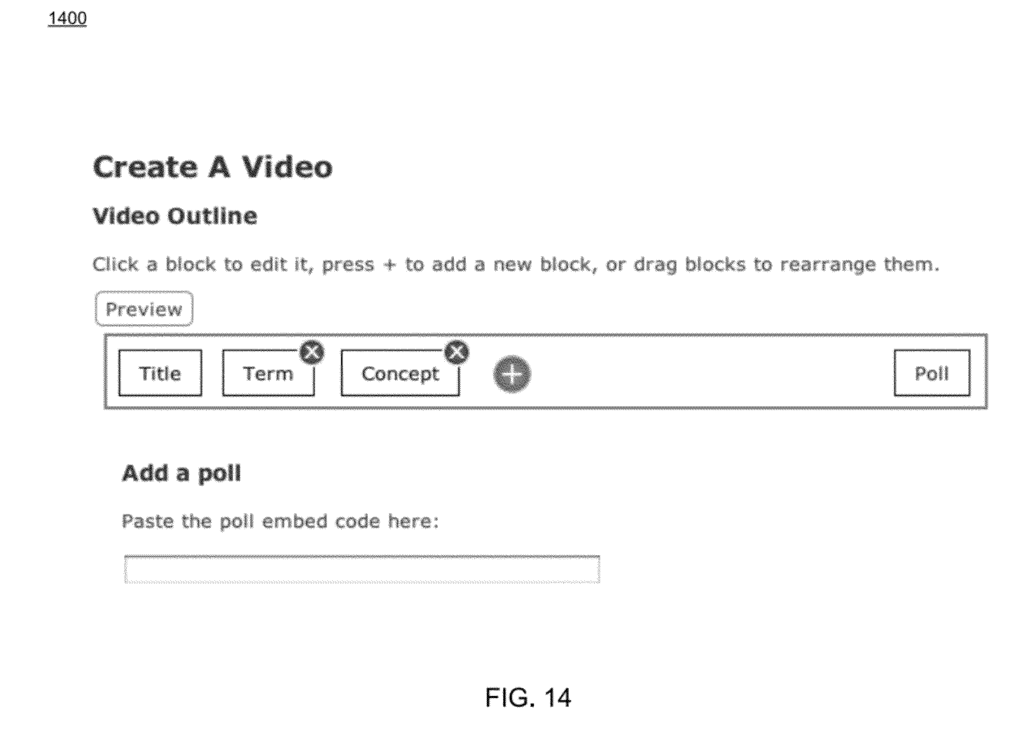

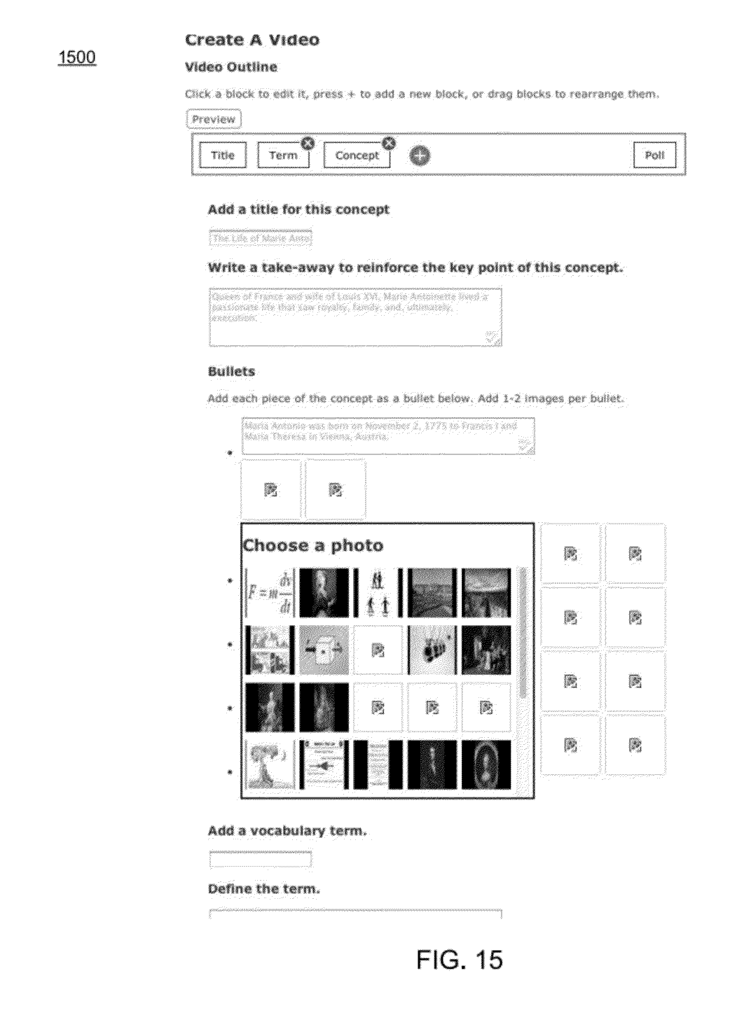

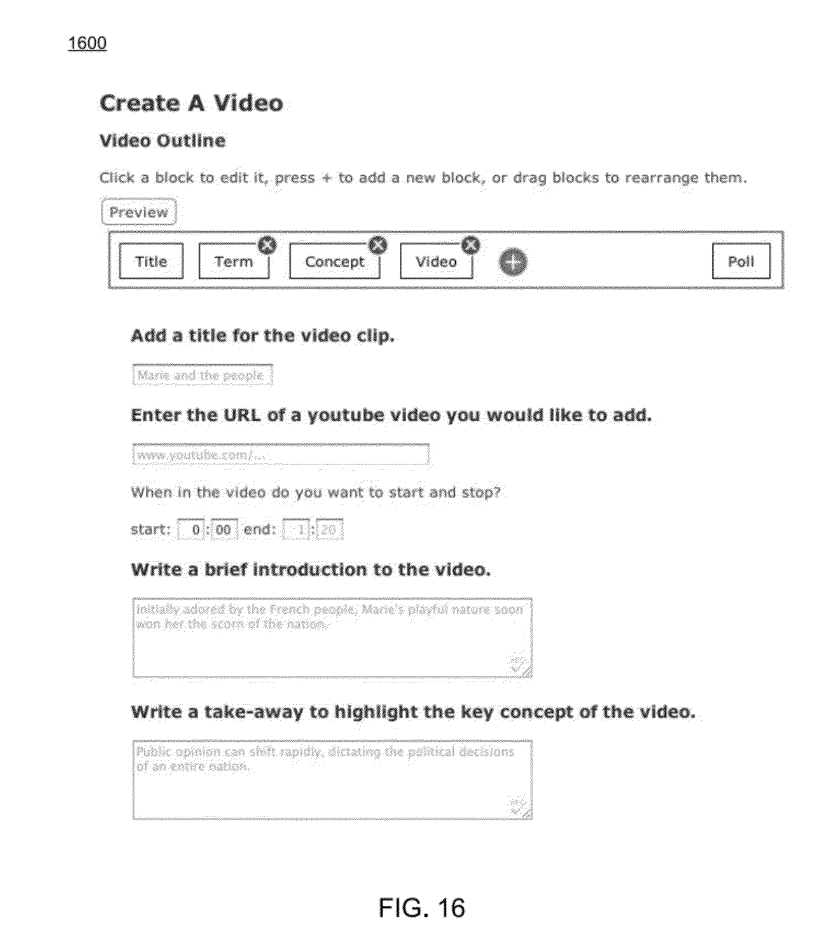

Referring now to FIGS. 8-16 embodiments showing various graphical user interfaces consistent with video generation process 10 is provided. Graphical user interfaces 800-1600 shows an example of video generation process 10 used in an educational environment. As shown in FIGS. 8-9, the user may be provided with a number of options associated with the video to be generated. For example, an option to select a theme may be provided. The user may also be prompted to add one or more blocks, which may include, but are not limited to, Title, Concept, Term, Video, etc. FIG. 10 depicts a template 1000 configured to allow a user to edit a concept block associated with template 1000. In this particular example, the user has entered “The Life of Marie Antoinette” as the Title for the educational concept. Accordingly, text, images and videos may be uploaded and associated with the template as discussed herein. FIG. 12 depicts template 1200 configured to allow the user to add and/or define a vocabulary term associated with the educational concept. FIG. 13 shows template 1300 that allows for the rearranging of blocks prior to video generation. FIG. 14 shows template 1400 that includes a poll feature. FIG. 15 shows template 1500 that is configured to allow a user to upload one or more photos prior to video generation. FIG. 16 shows template 1600 that is configured to allow a user to upload a video prior to video generation. As shown in FIG. 16, the video may include a URL of a video, stop and start times, an introduction to the video, and/or a key concept section. Numerous additional embodiments are also within the scope of the present disclosure.

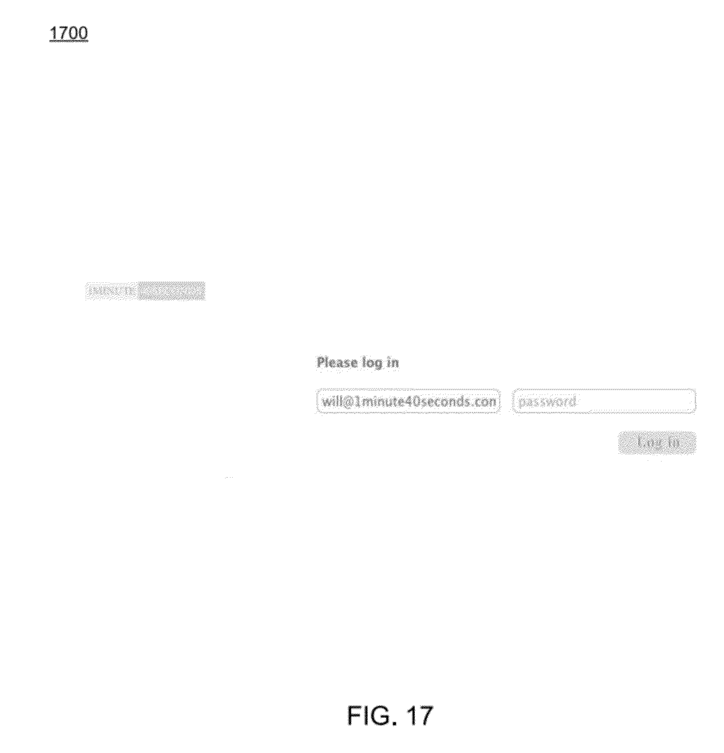

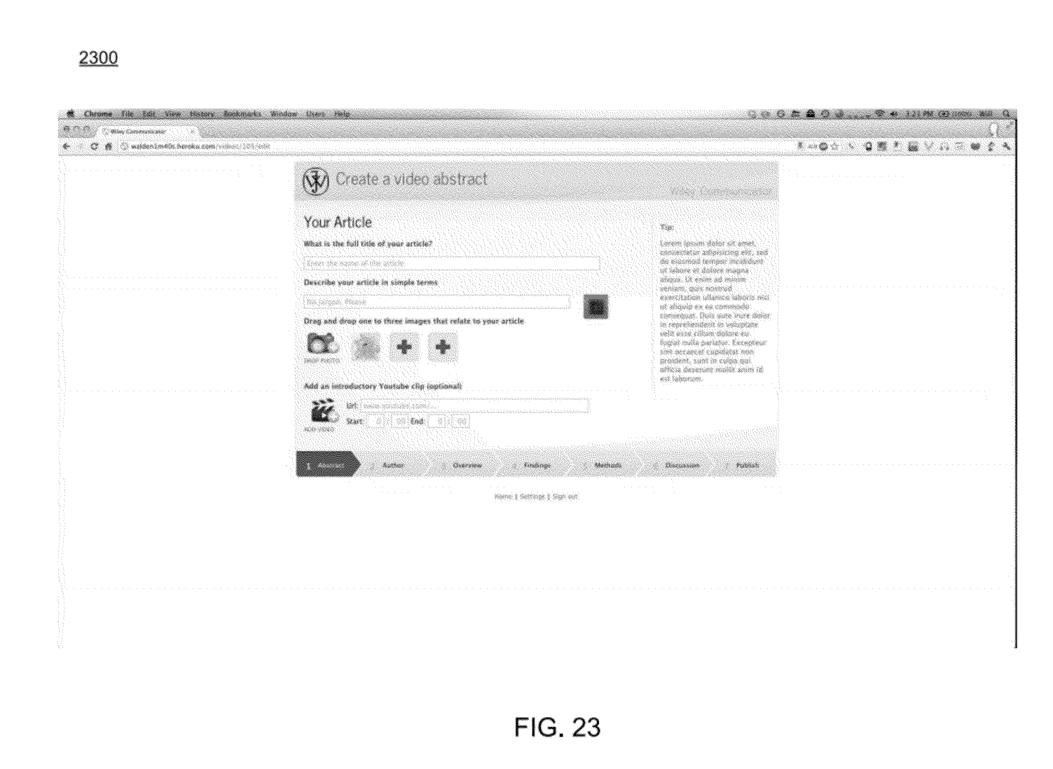

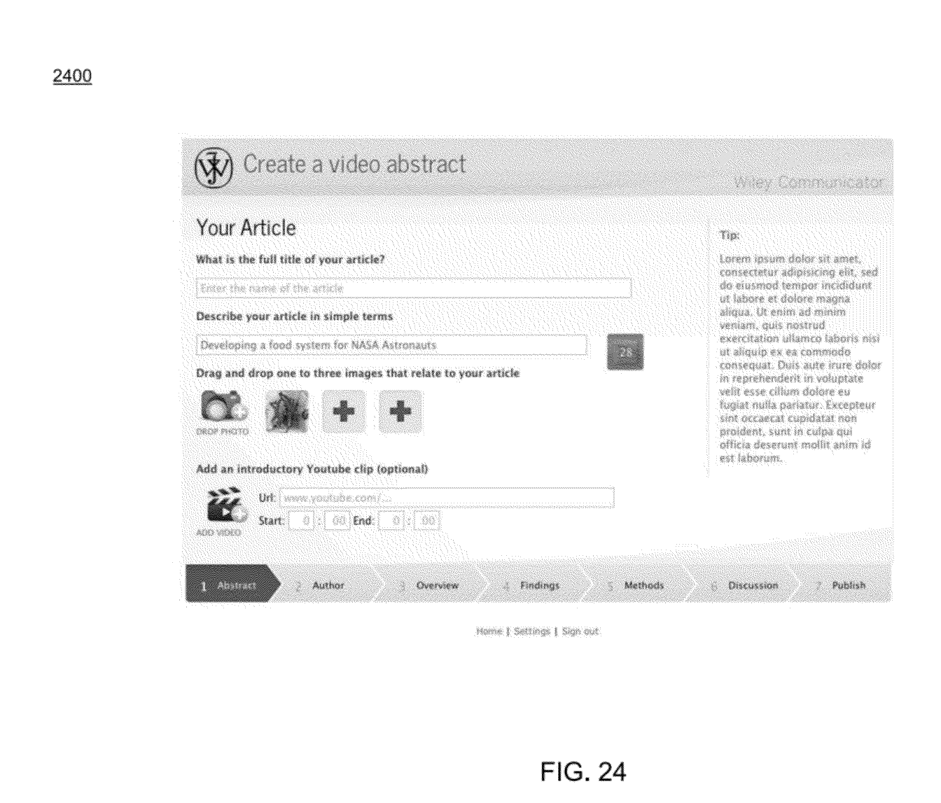

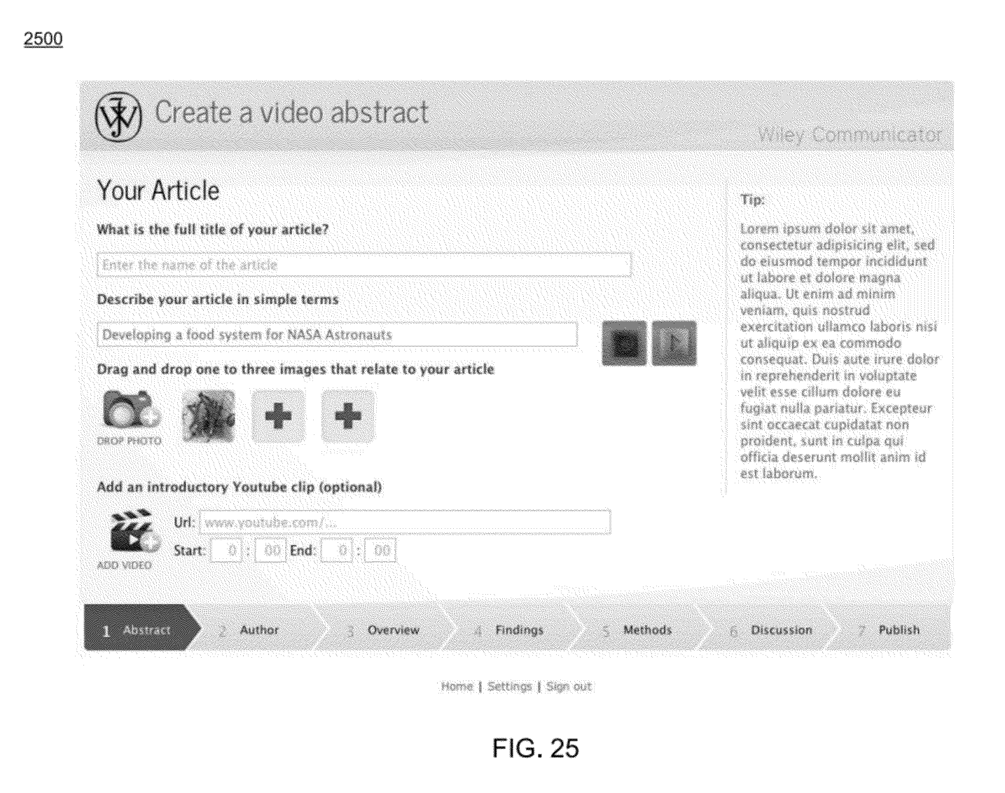

Referring now to FIGS. 17-35 embodiments showing various graphical user interfaces consistent with video generation process 10 is provided. Graphical user interfaces 1700-3500 shows an example of video generation process 10 used in a publishing environment.

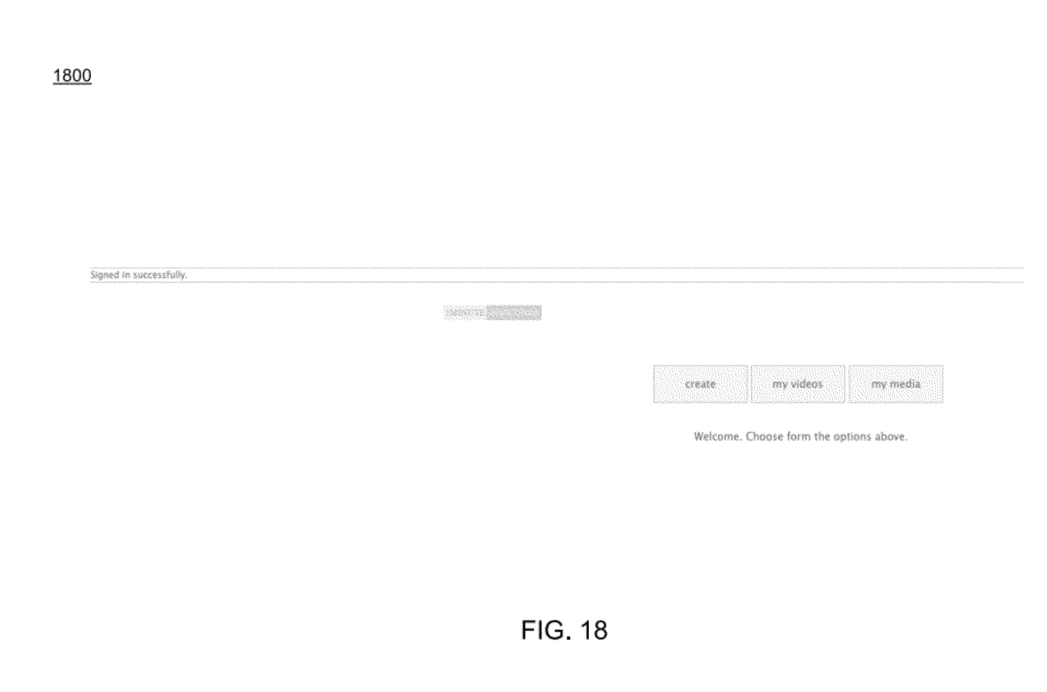

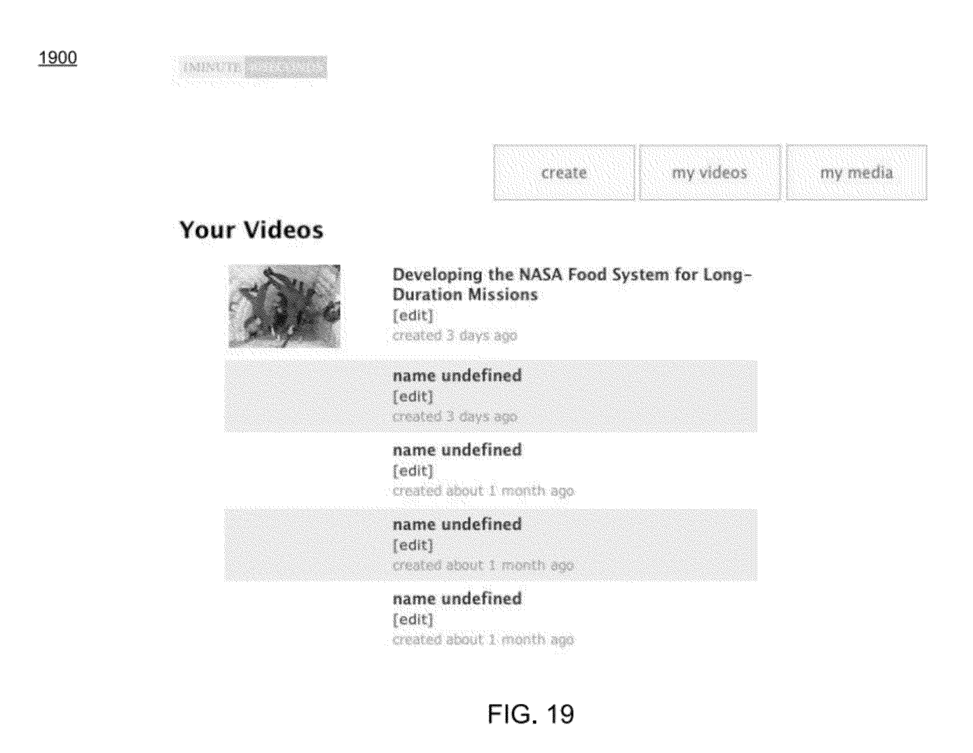

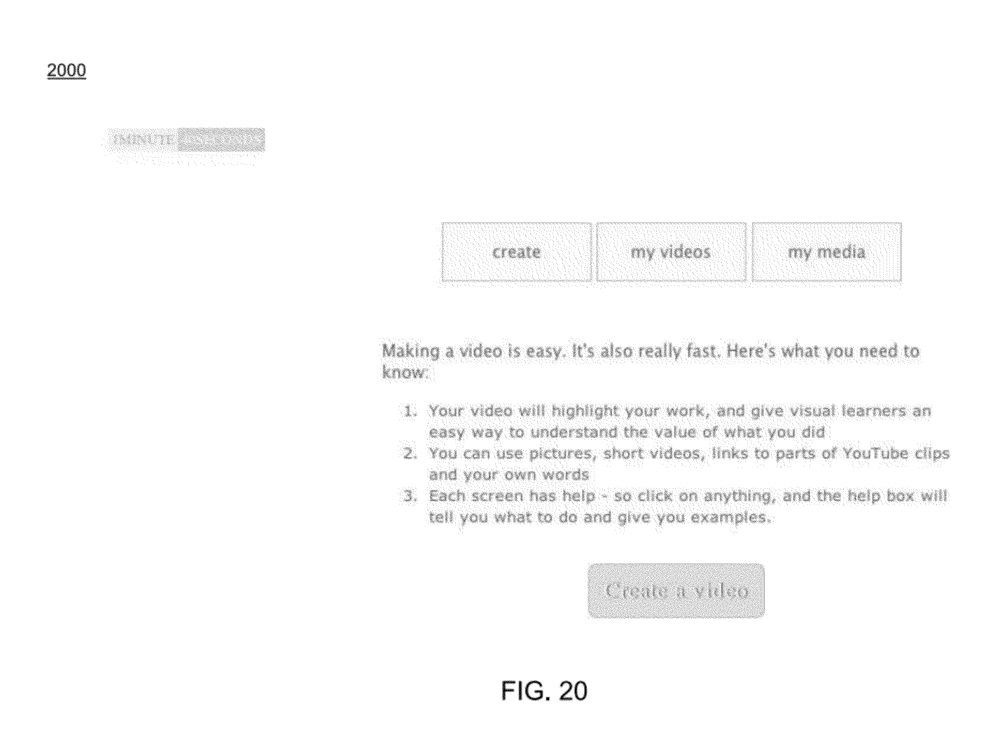

FIGS. 17-18 depict various graphical user interfaces of exemplary sign-in pages consistent with embodiments of the present disclosure. FIG. 19 depicts a user's video page consistent with an embodiment of the present disclosure. FIG. 20 depicts a an initial video creation page consistent with an embodiment of the present disclosure.

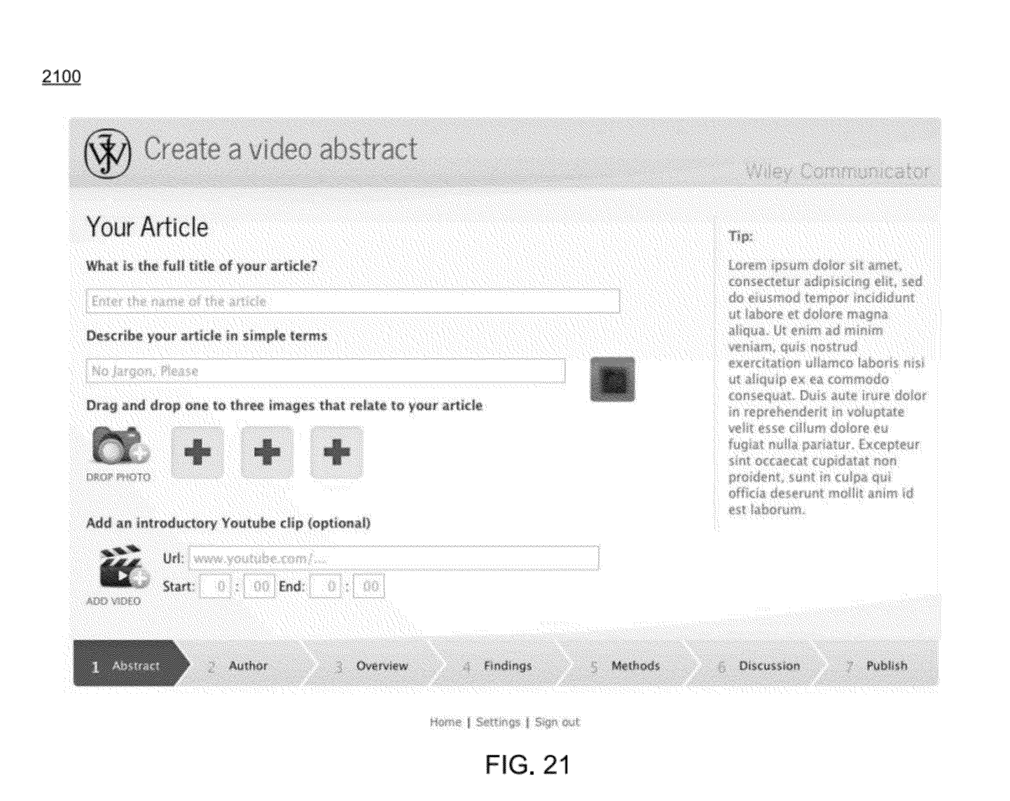

Referring now to FIG. 21, a template 2100 consistent with embodiment of the present disclosure is provided. In this example, the template may include abstract information, author information, overview information, findings information, methods information, discussion information, and publishing information.

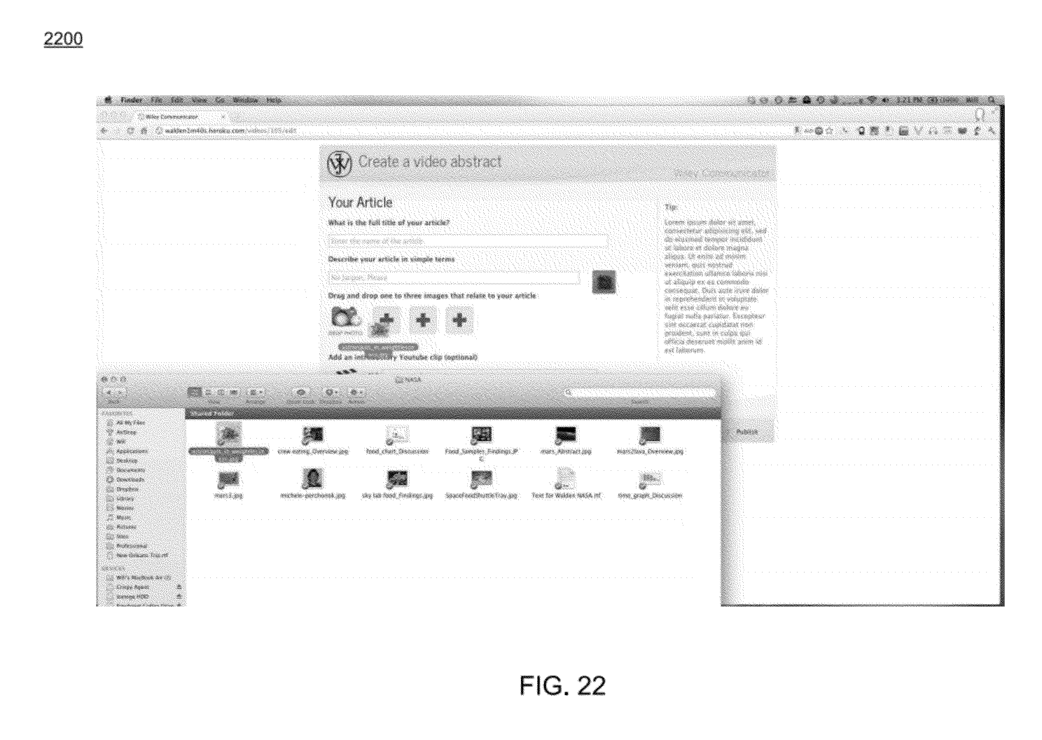

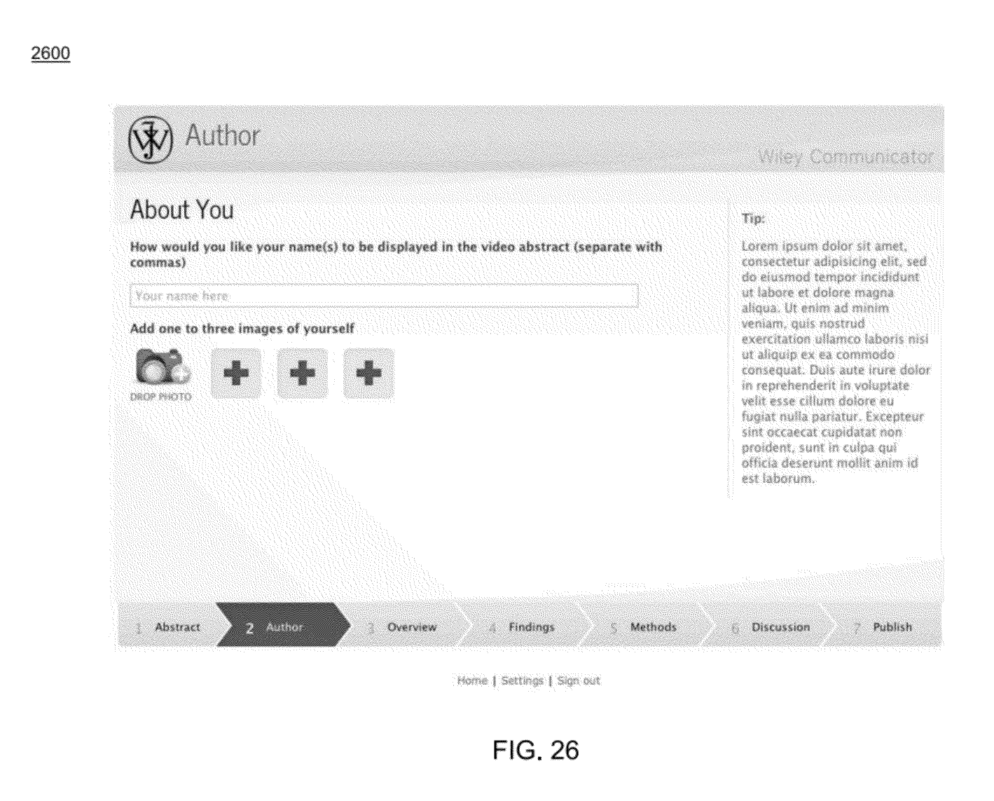

Template 2100 may be used to generate a video abstract, which may be used in the publishing industry. Template 2100 may allow a user to enter the title of an article, a description of the article, add images, video clips, and set starting and ending times of the video as shown in FIG. 21. FIGS. 22-25 depict various stages of the template as a user has inserted and/or uploaded data into the template. FIG. 26 shows an exemplary user interface through which information about the author may be inserted.

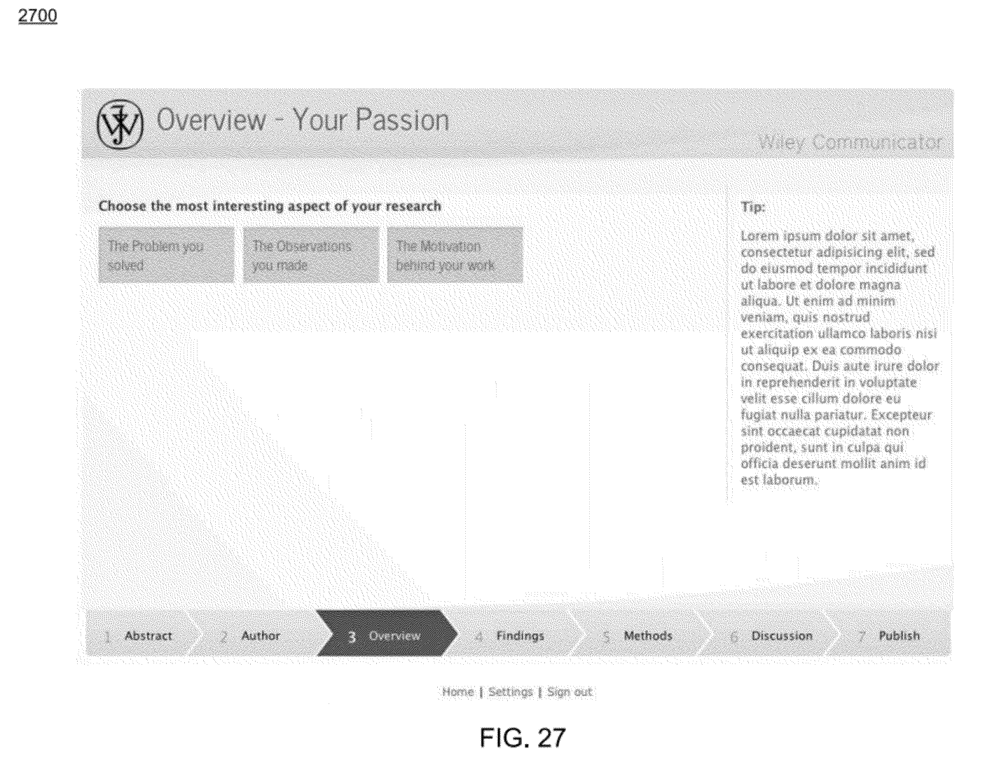

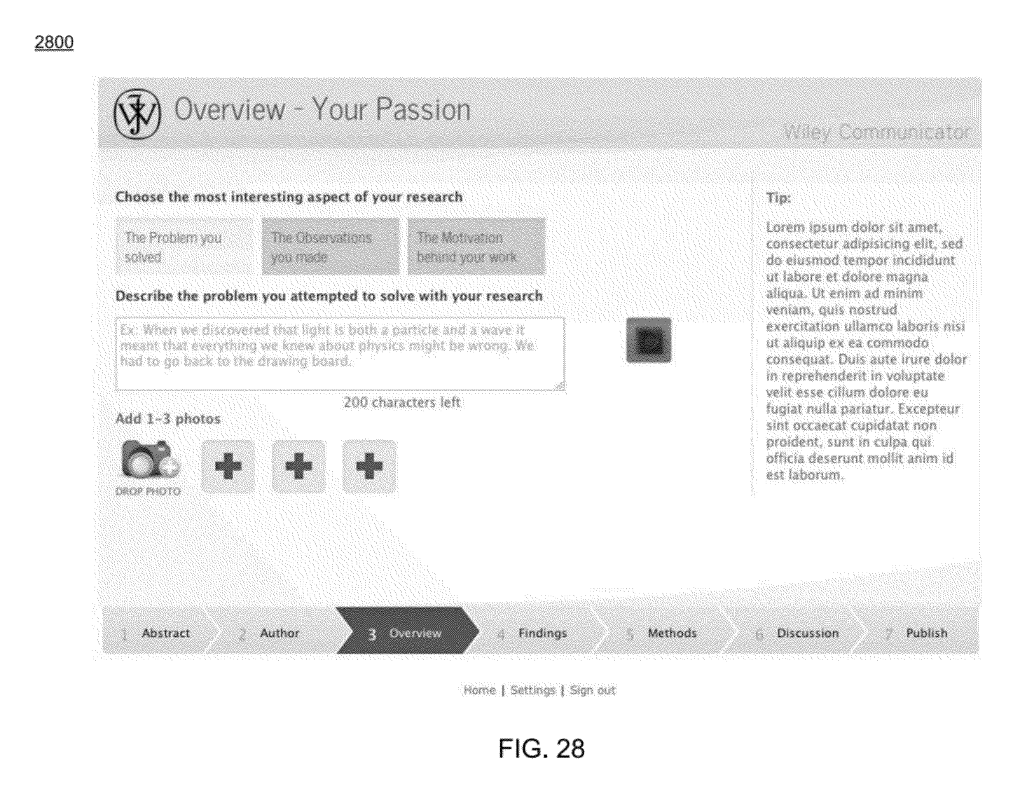

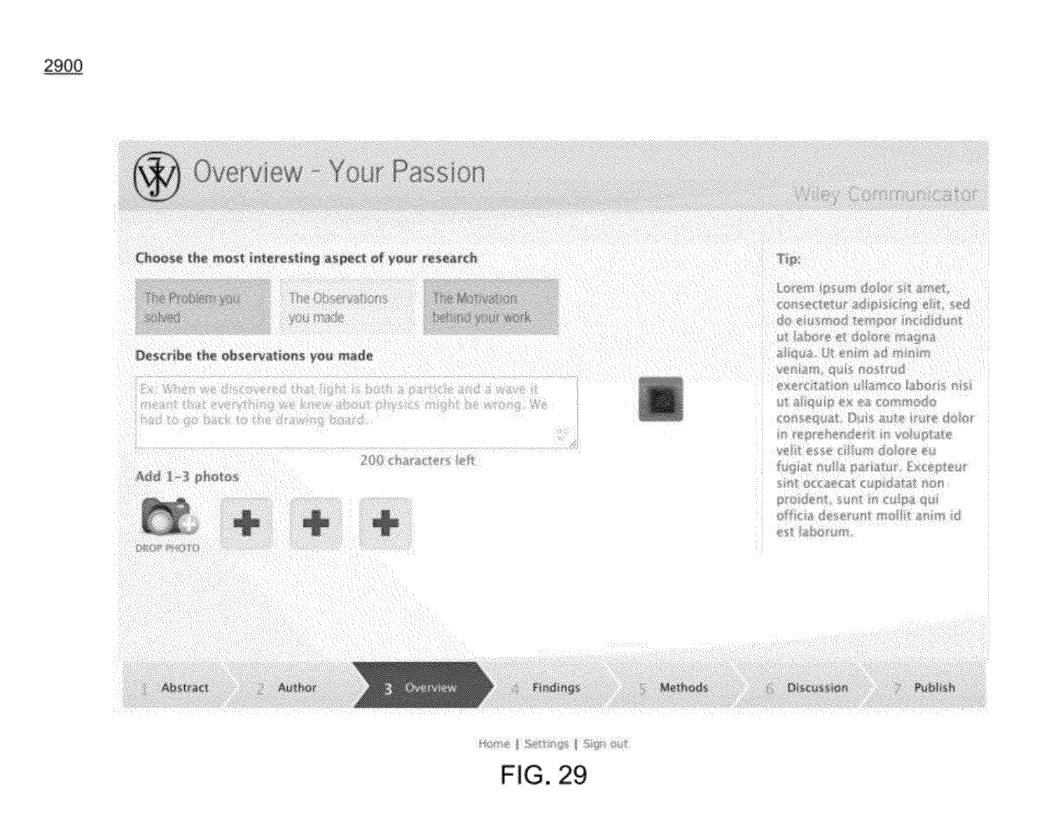

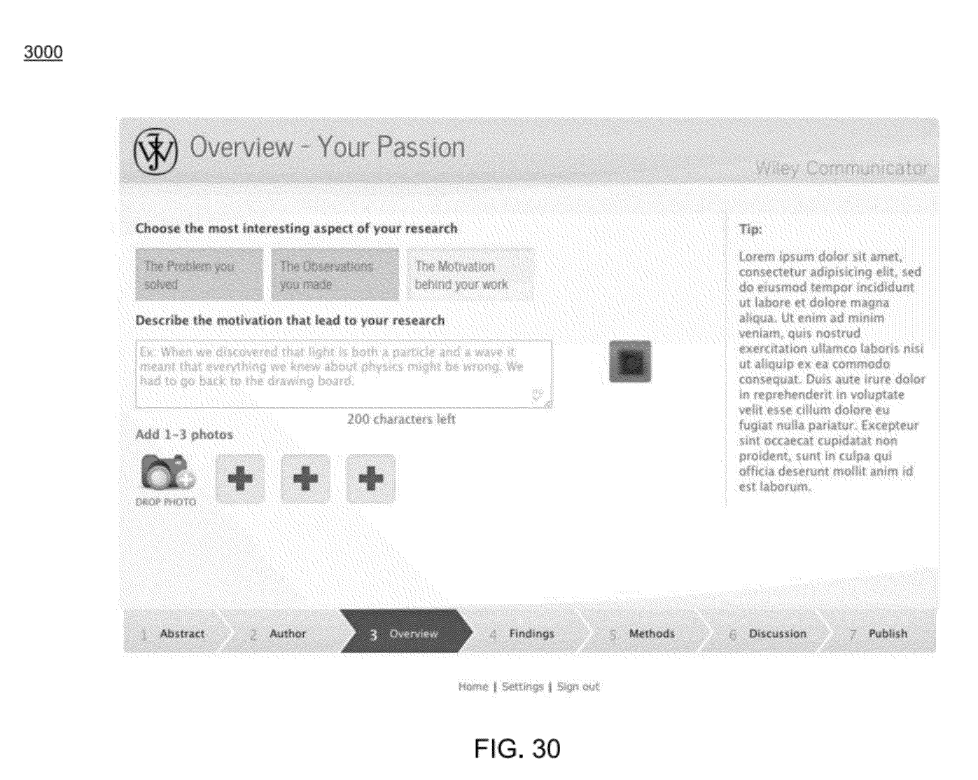

Referring now to FIGS. 27-30, a template 2700 showing an embodiment of an overview page is provided. In this particular example, the overview page may allow a user to insert the problem solved (FIG. 28), observations made (FIG. 29), motivation behind your work (FIG. 30), etc.

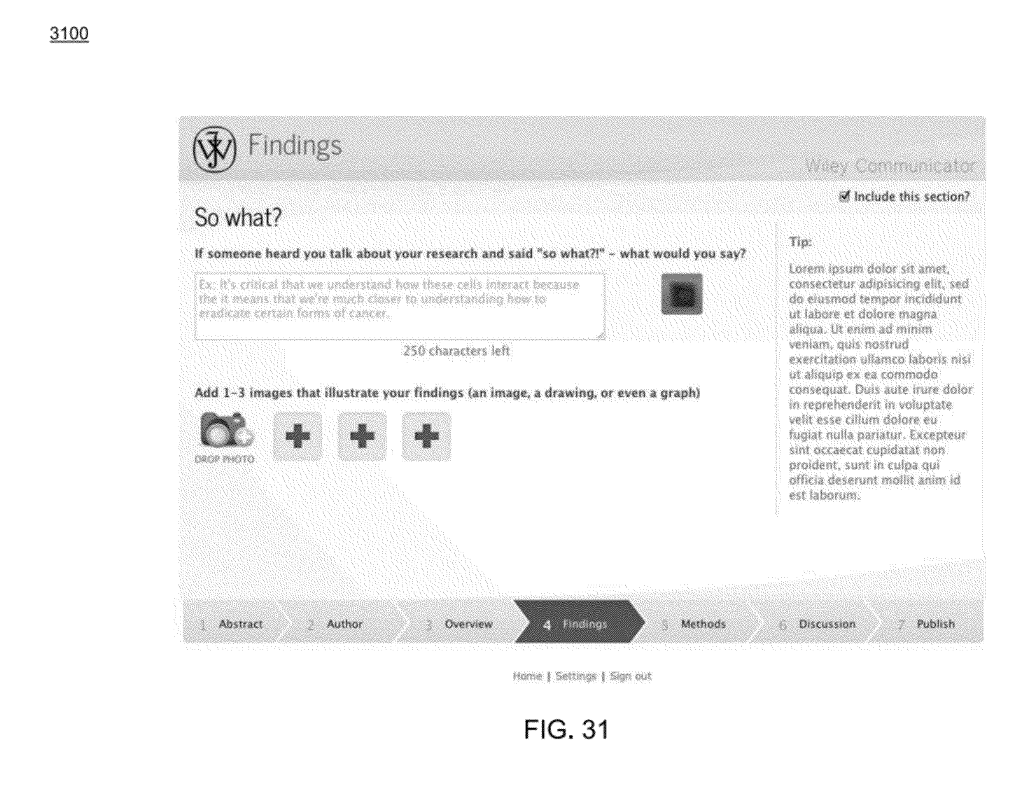

Referring now to FIG. 31, a template 3100 showing an embodiment of a findings page is provided. A description as well as photos and videos may be uploaded as shown in FIG. 31.

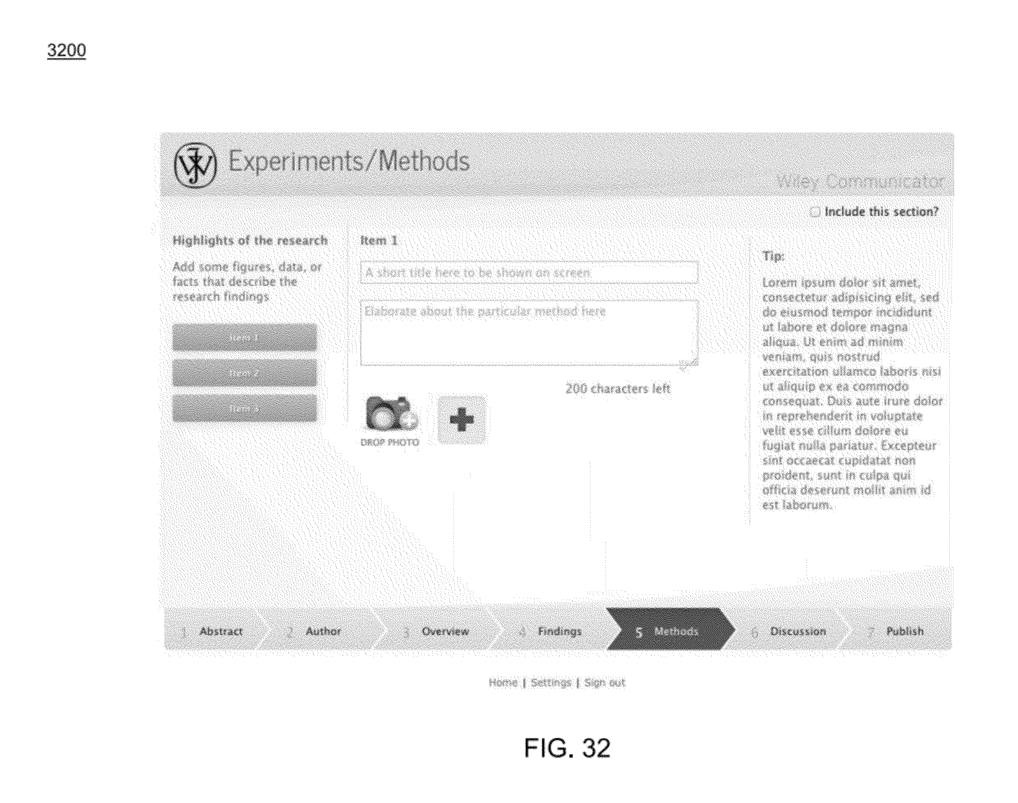

Referring now to FIG. 32, a template 3200 showing an embodiment of an experiments/methods page is provided. Again, the user may populate template 3200 with text, images, video, etc. In this particular example, data that describes the research findings may be provided.

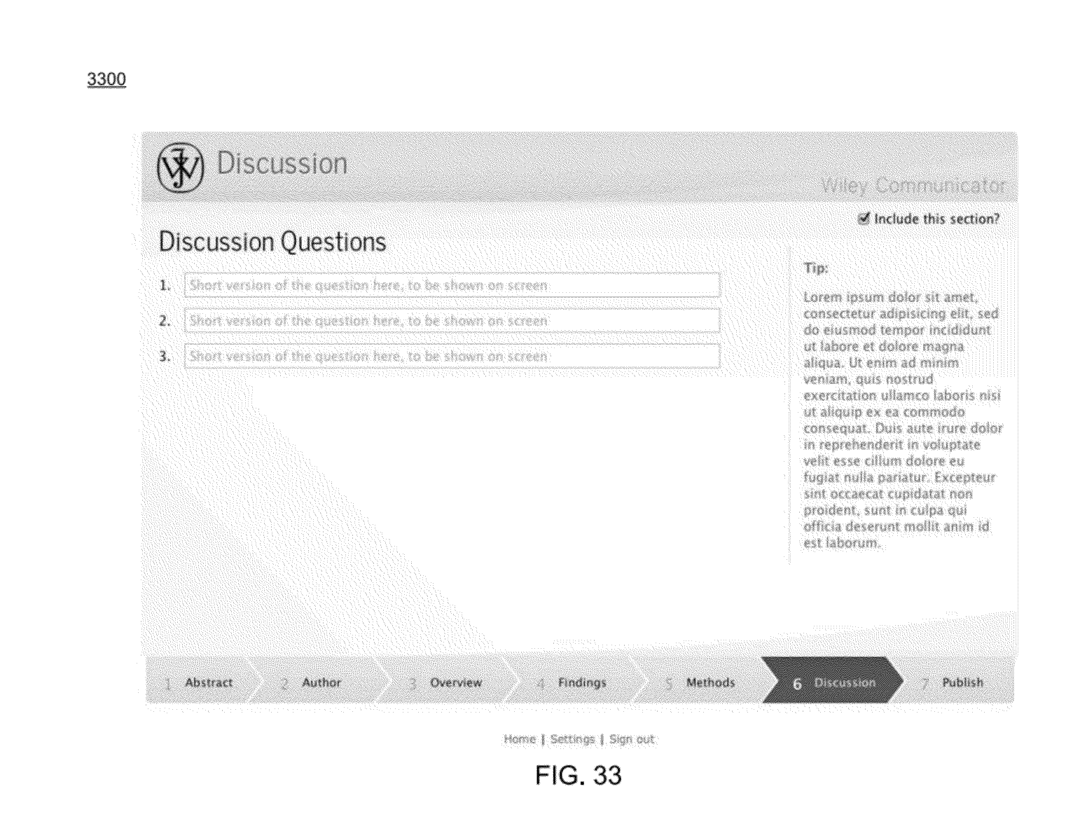

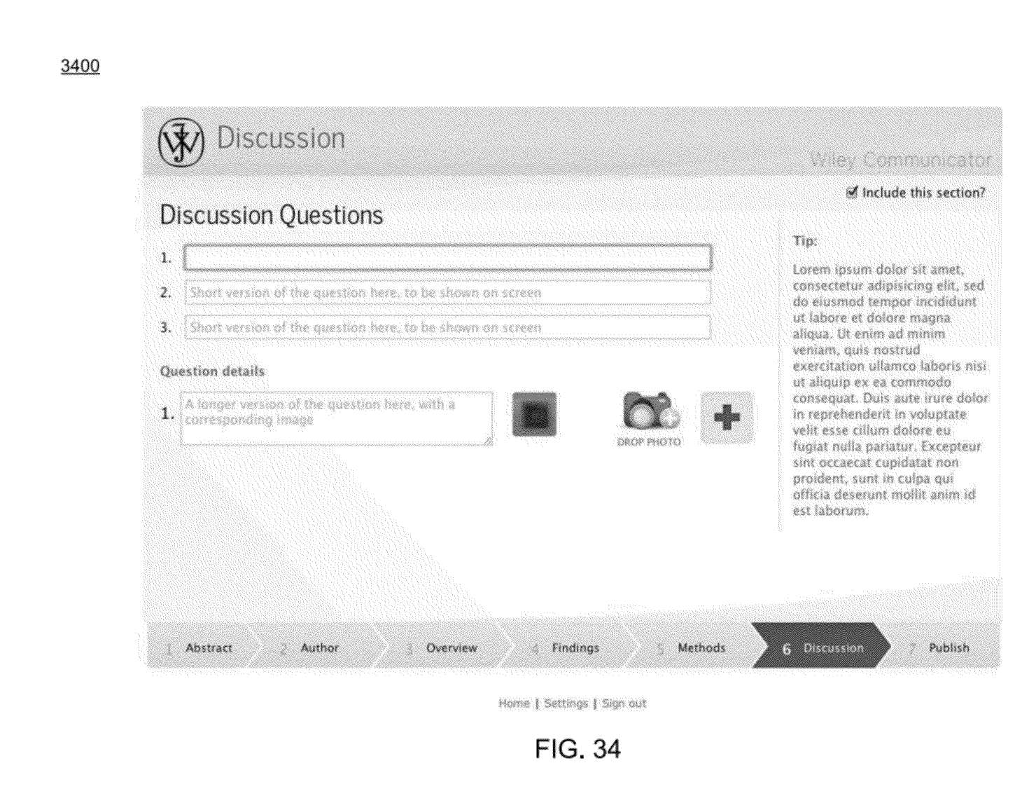

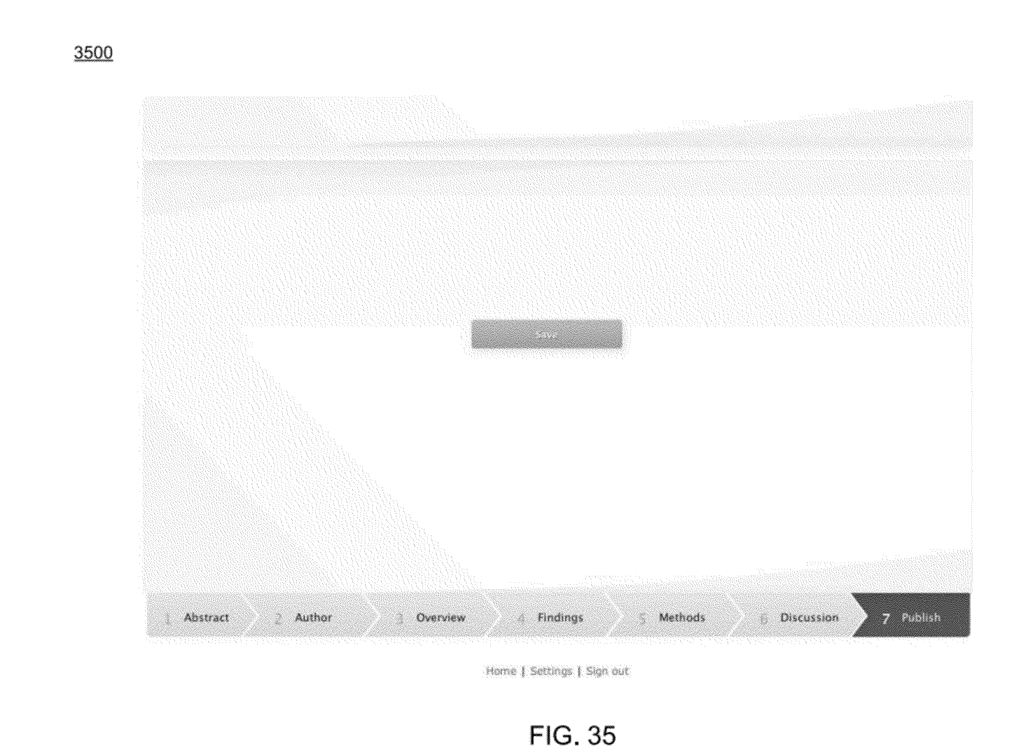

Referring now to FIG. 33, a template 3300 showing an embodiment of a discussion page is provided. Discussion page may allow for the insertion of various questions to be shown on the screen during the generated video. FIG. 34 shows another embodiment of the discussion page, which includes question details and the ability to insert photos and/or videos. FIG. 35 shows that the finished video may be saved for subsequent use. Numerous additional embodiments are also within the scope of the present disclosure.

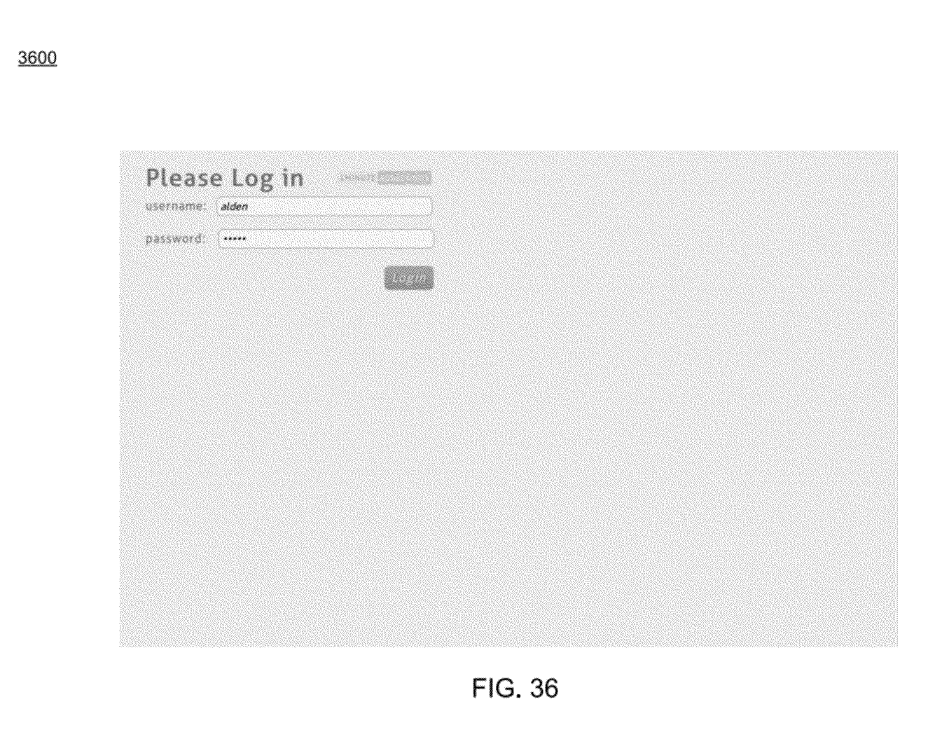

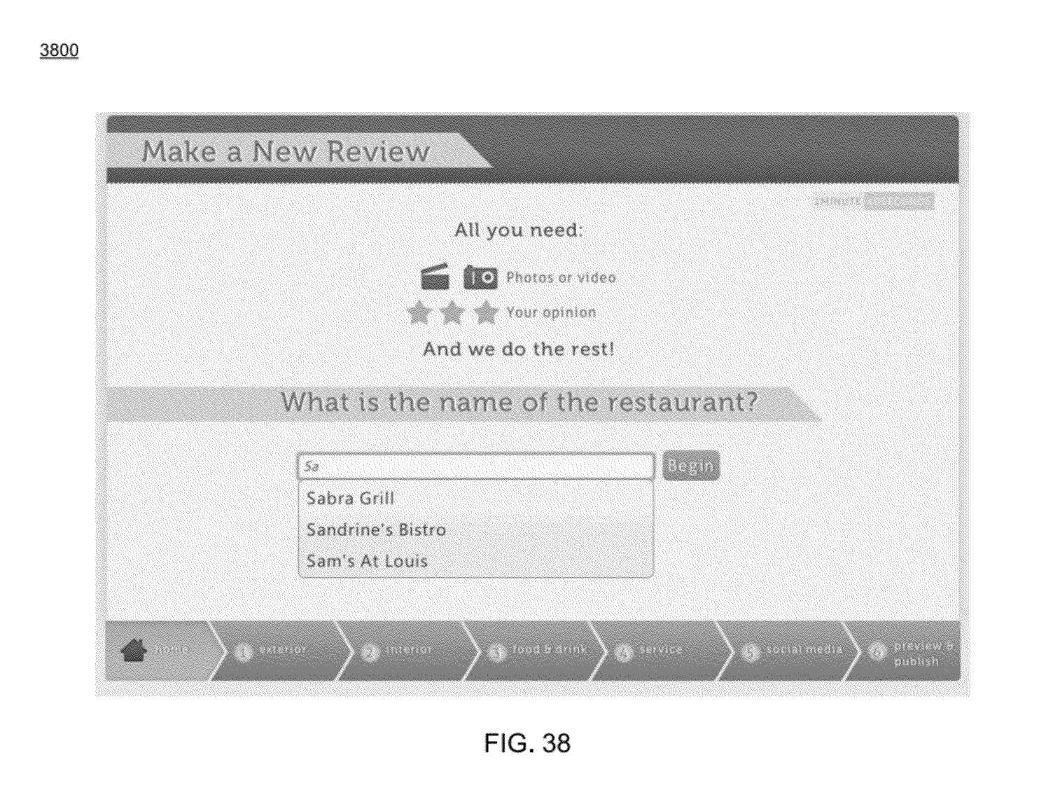

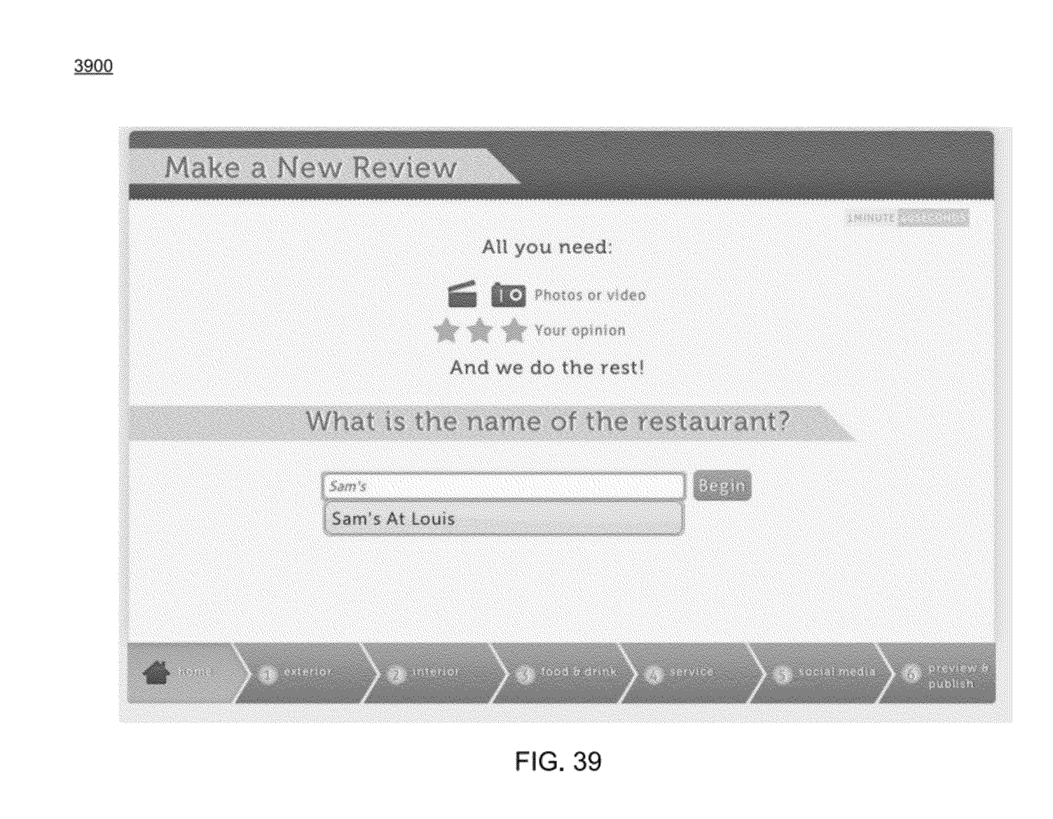

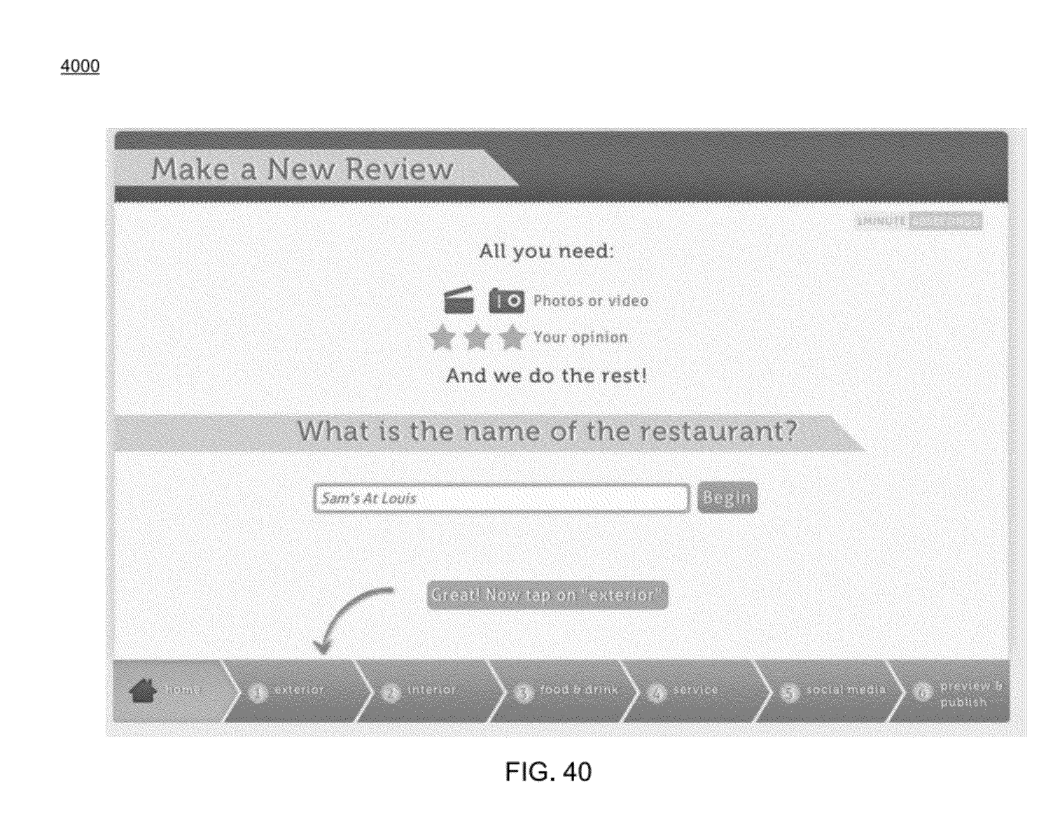

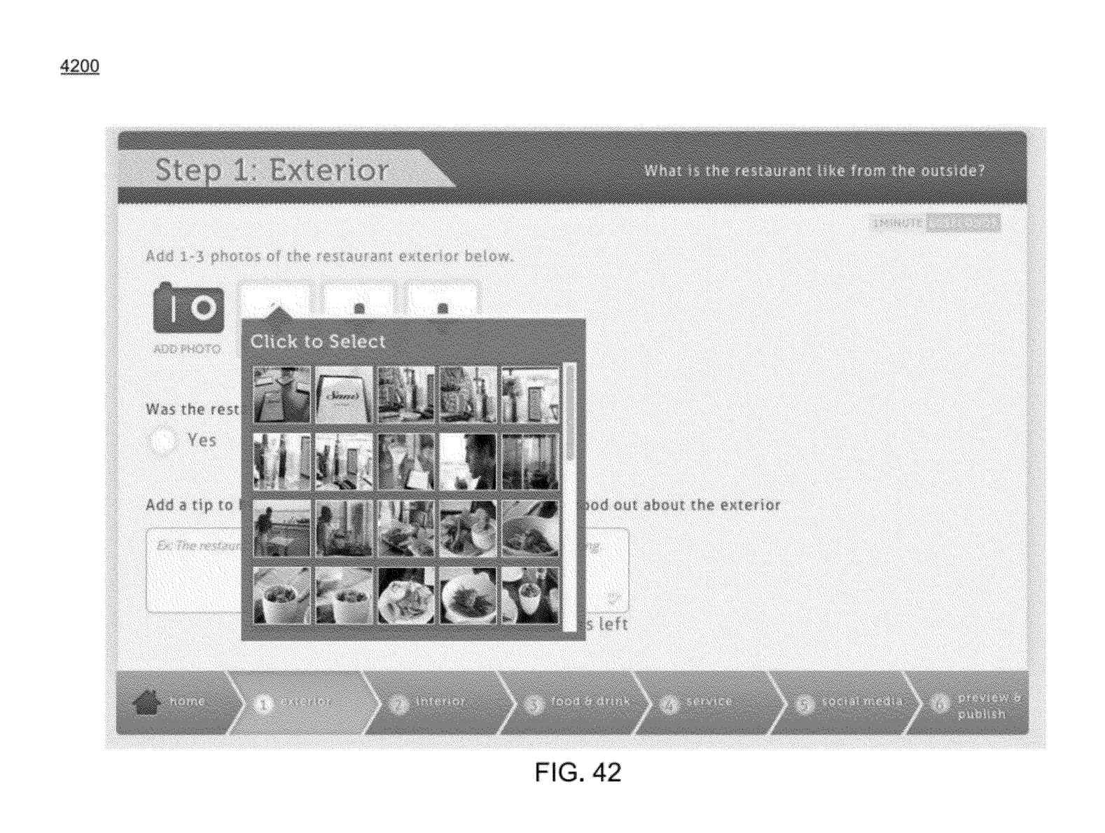

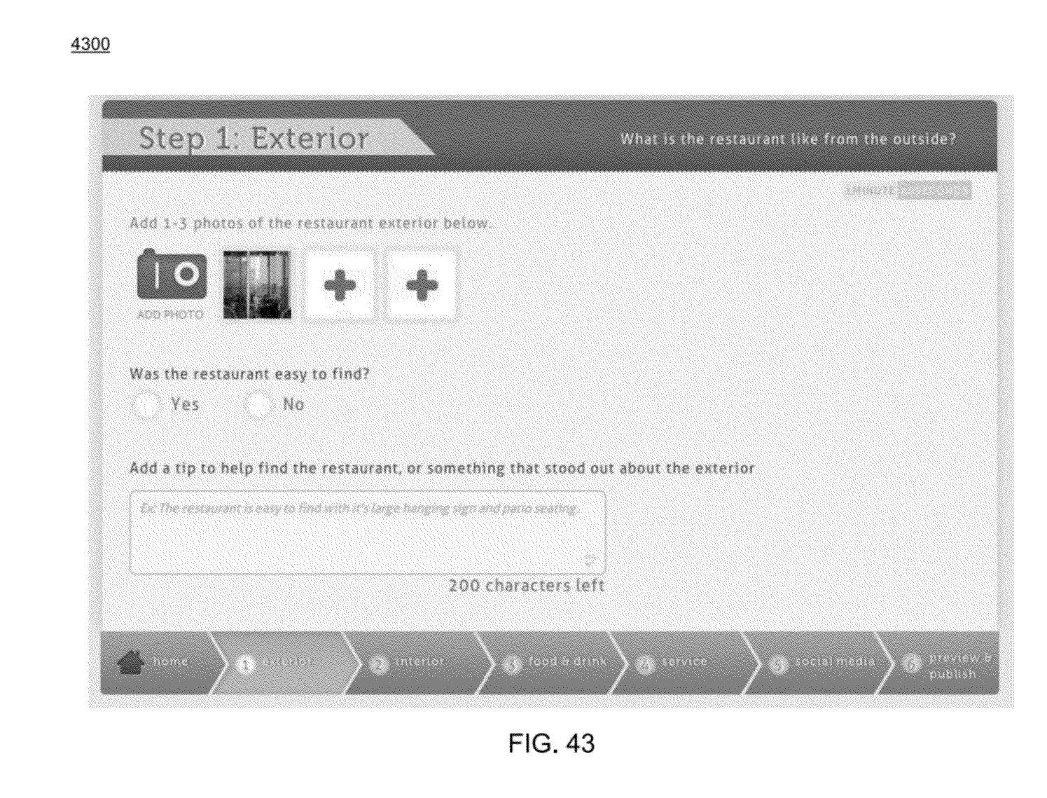

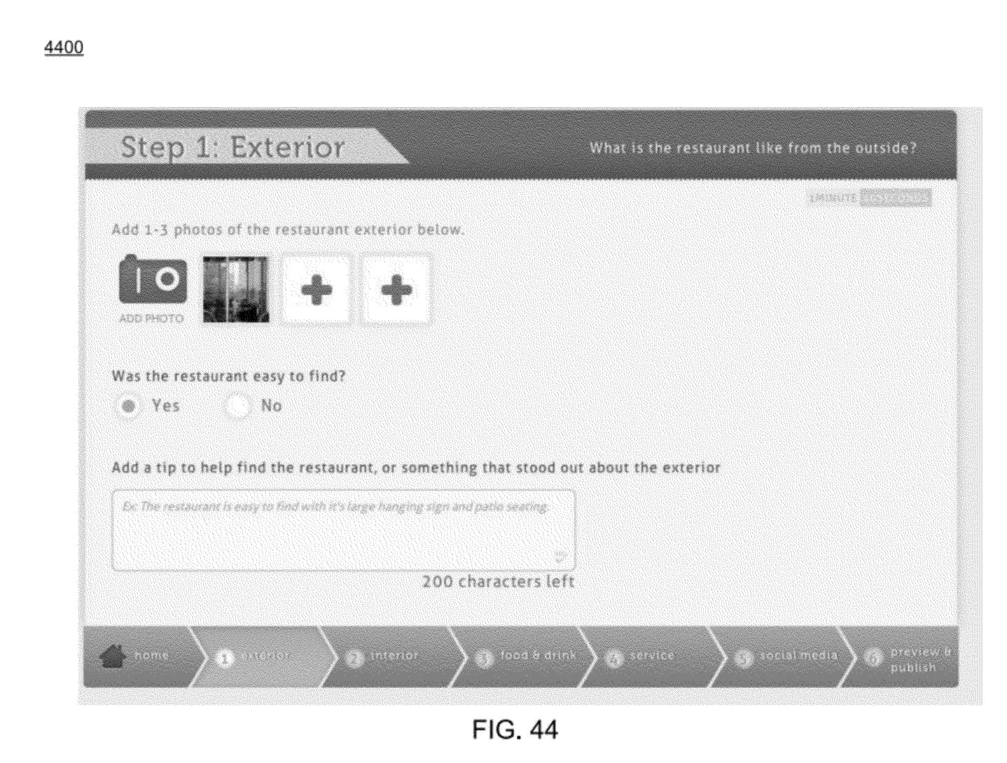

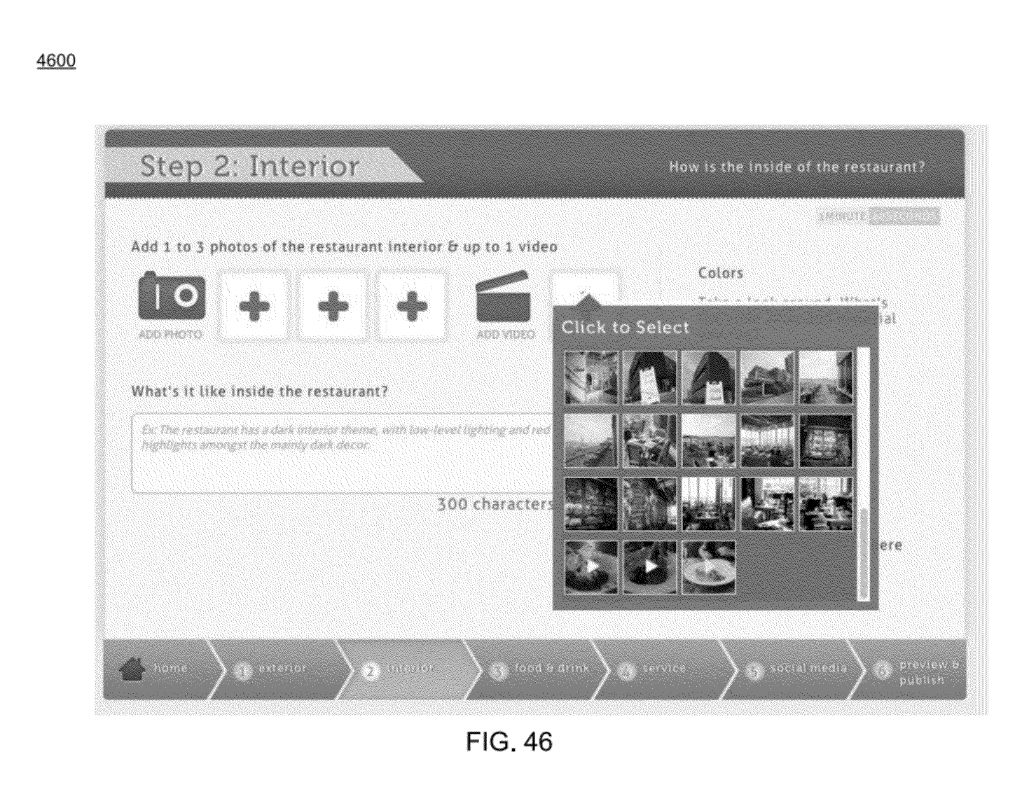

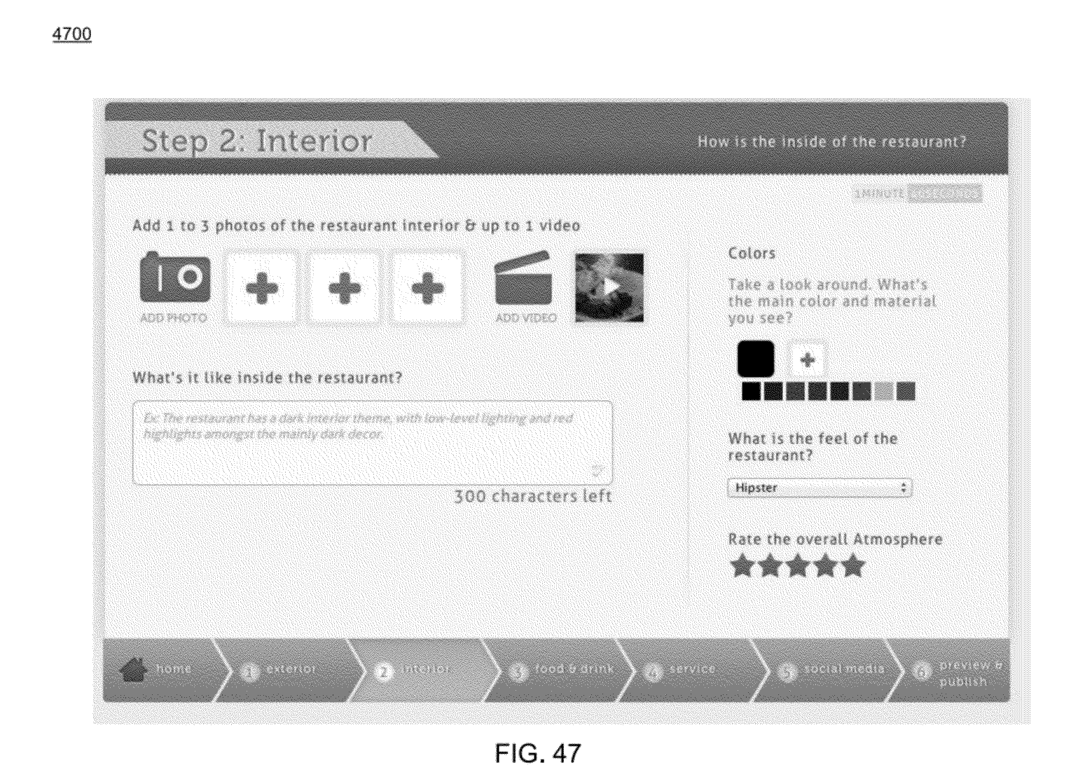

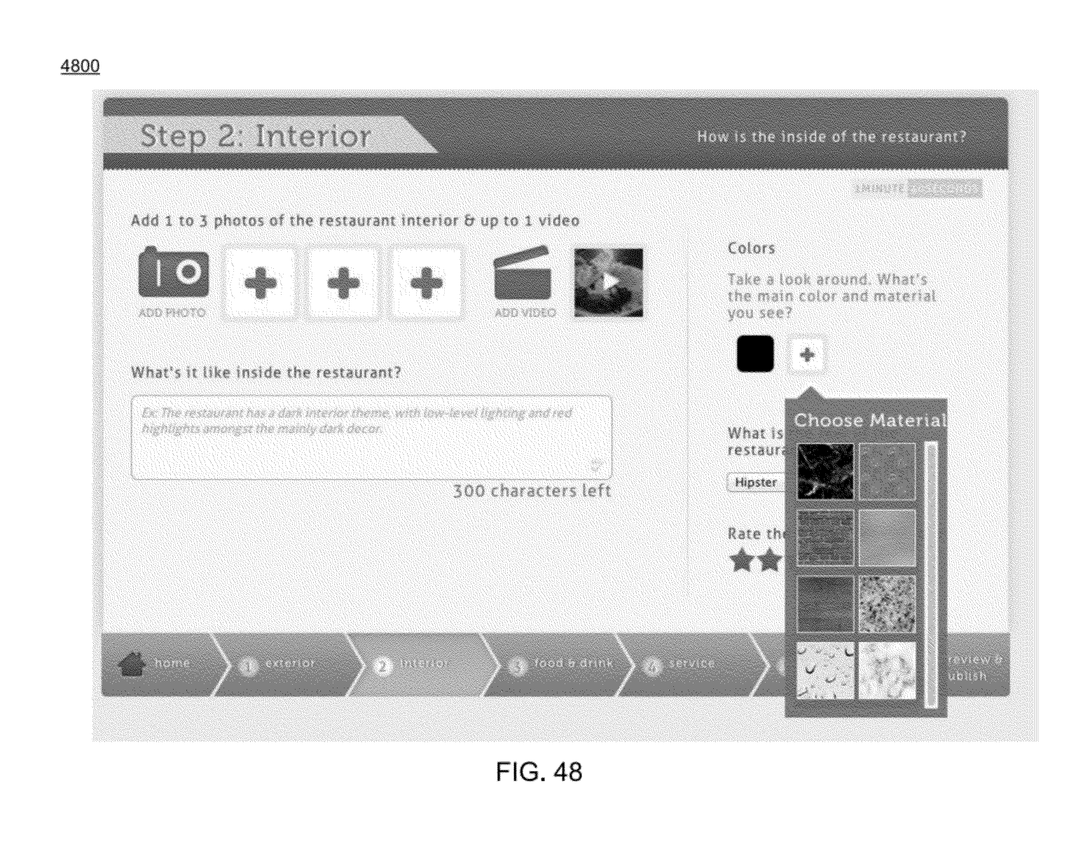

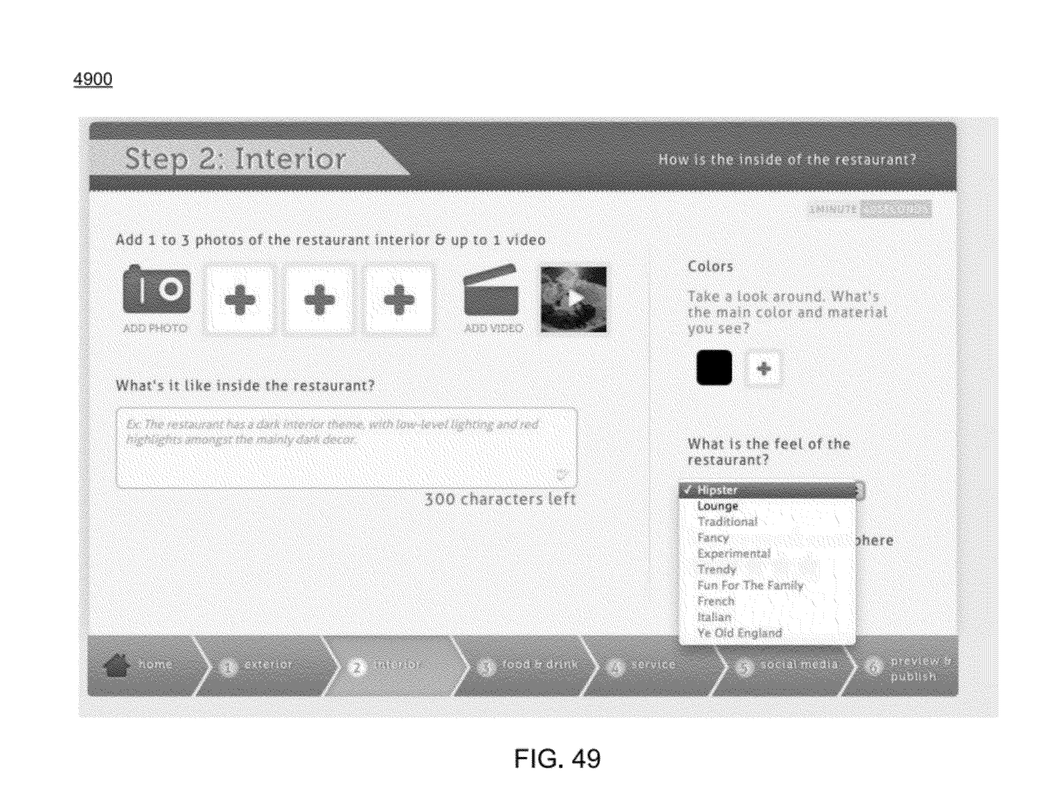

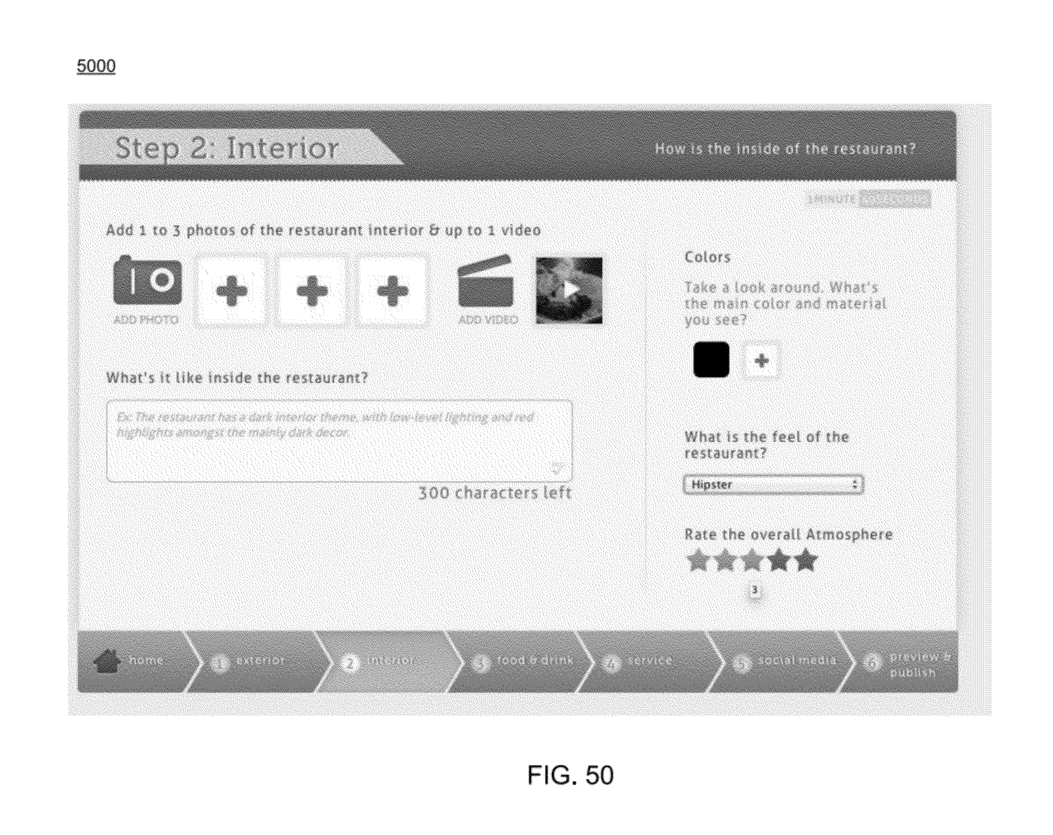

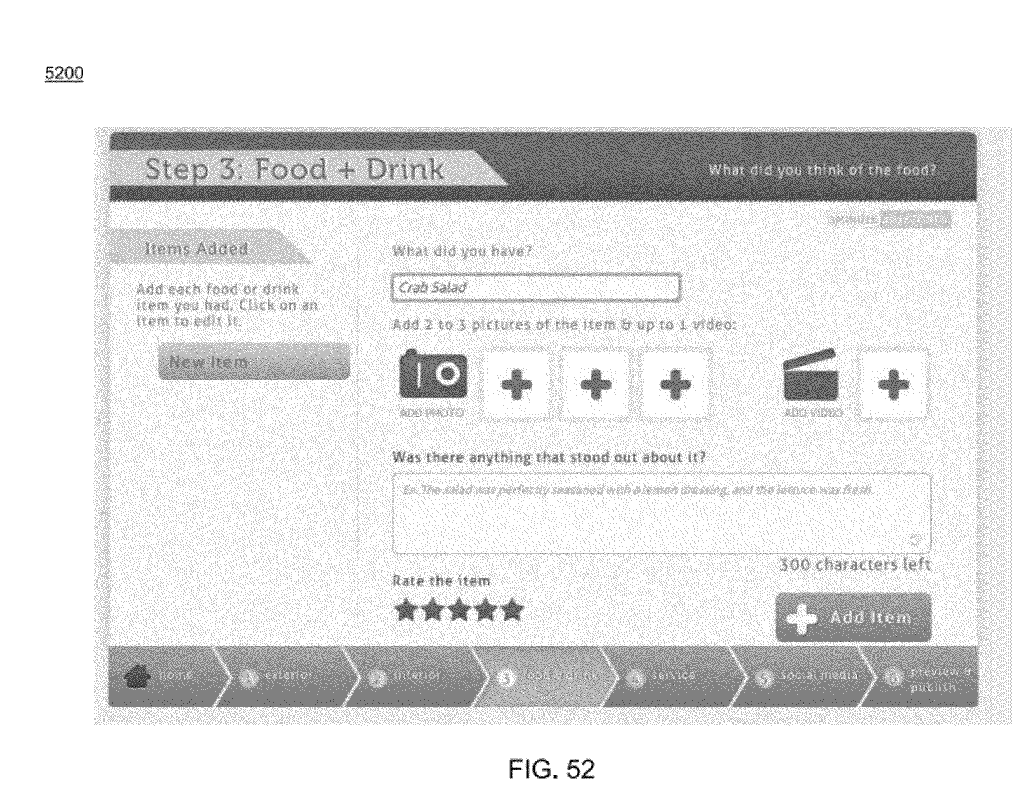

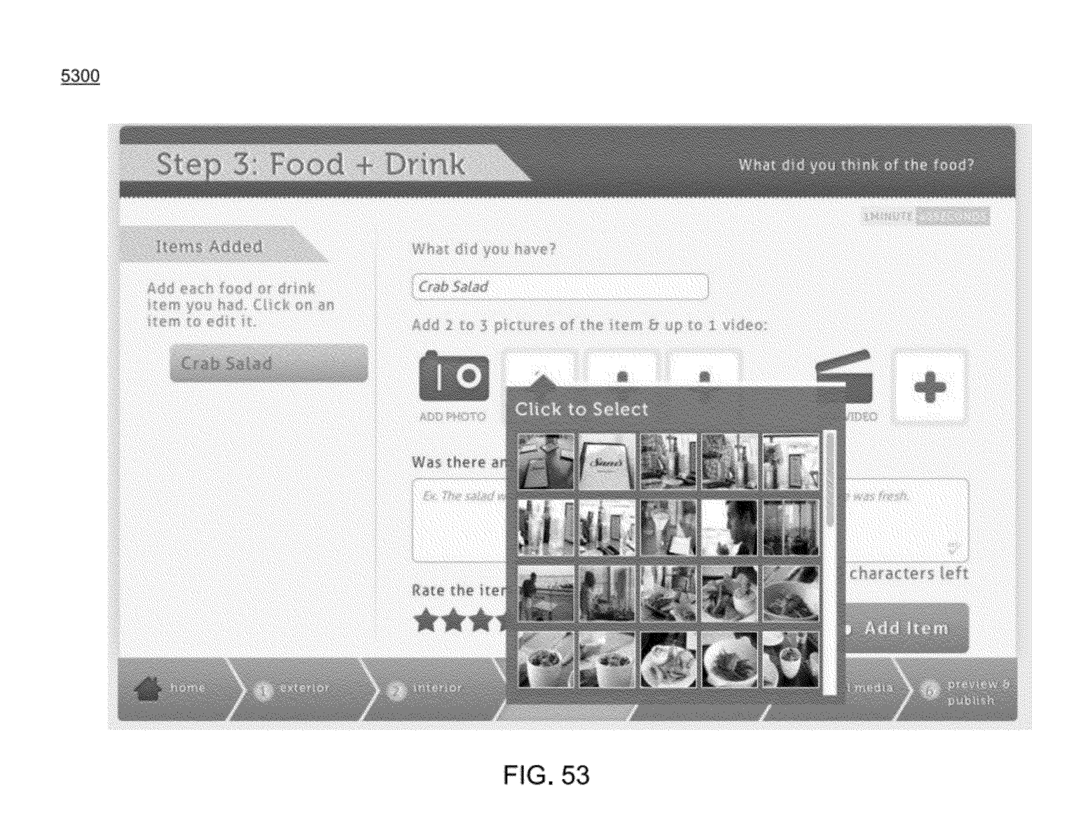

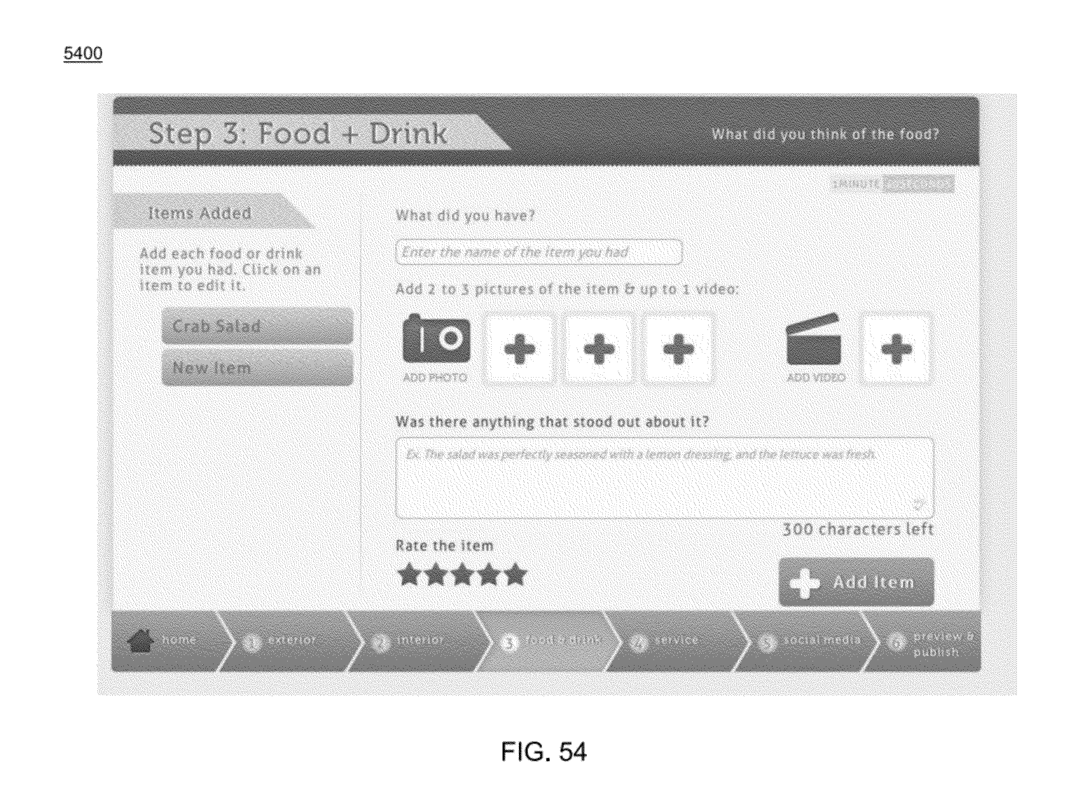

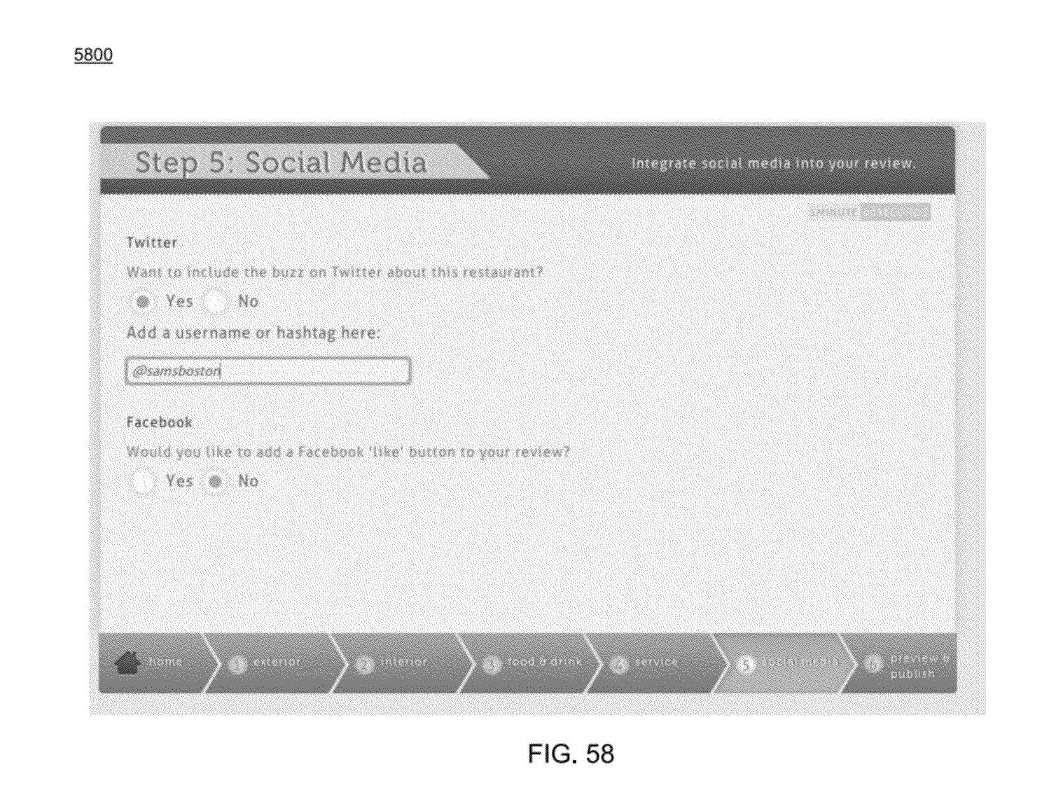

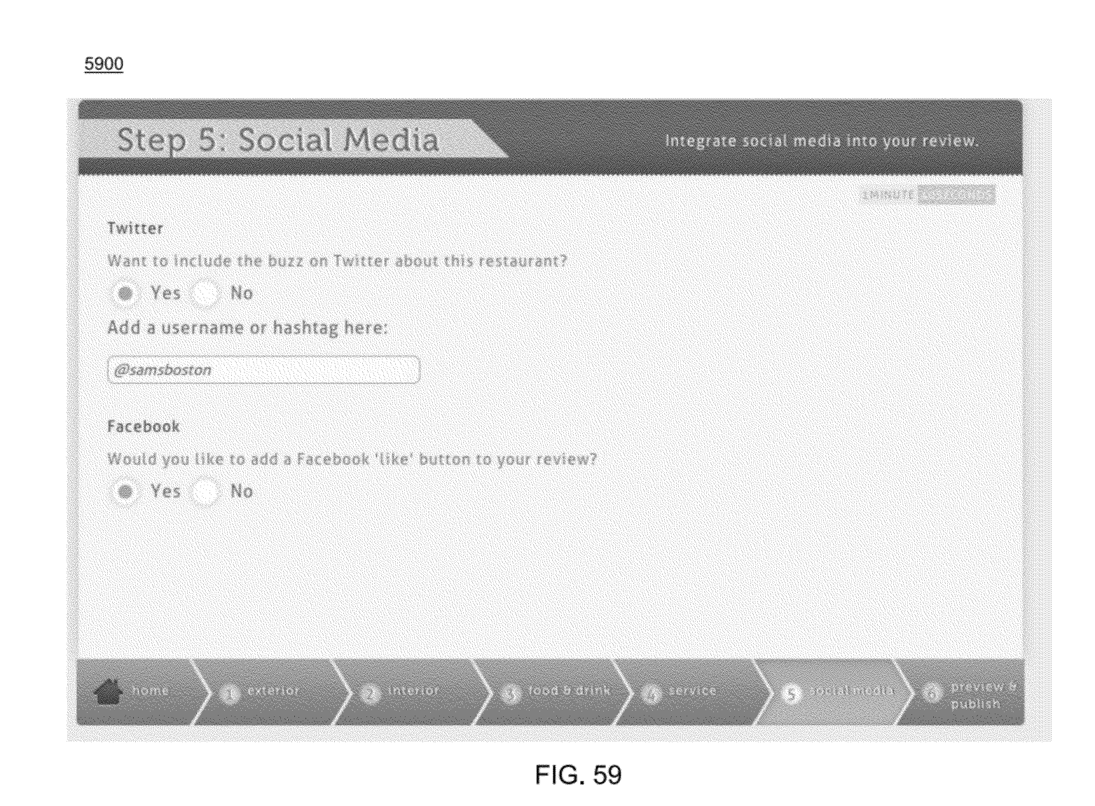

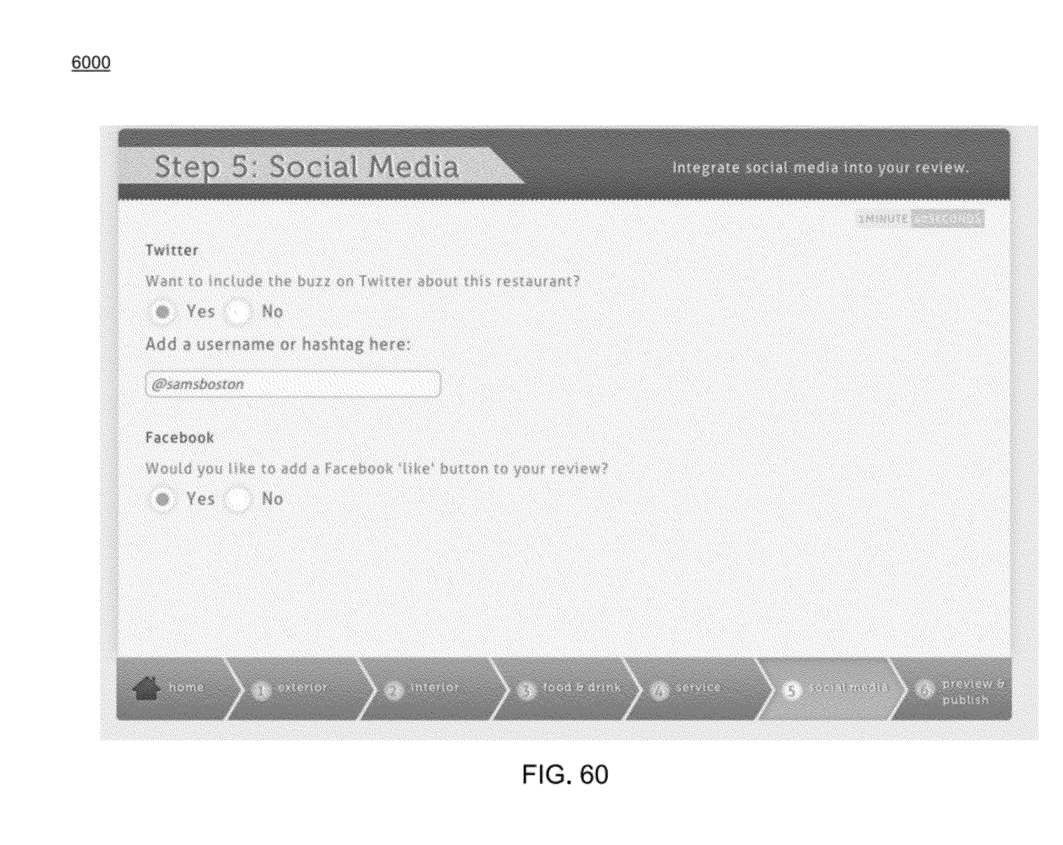

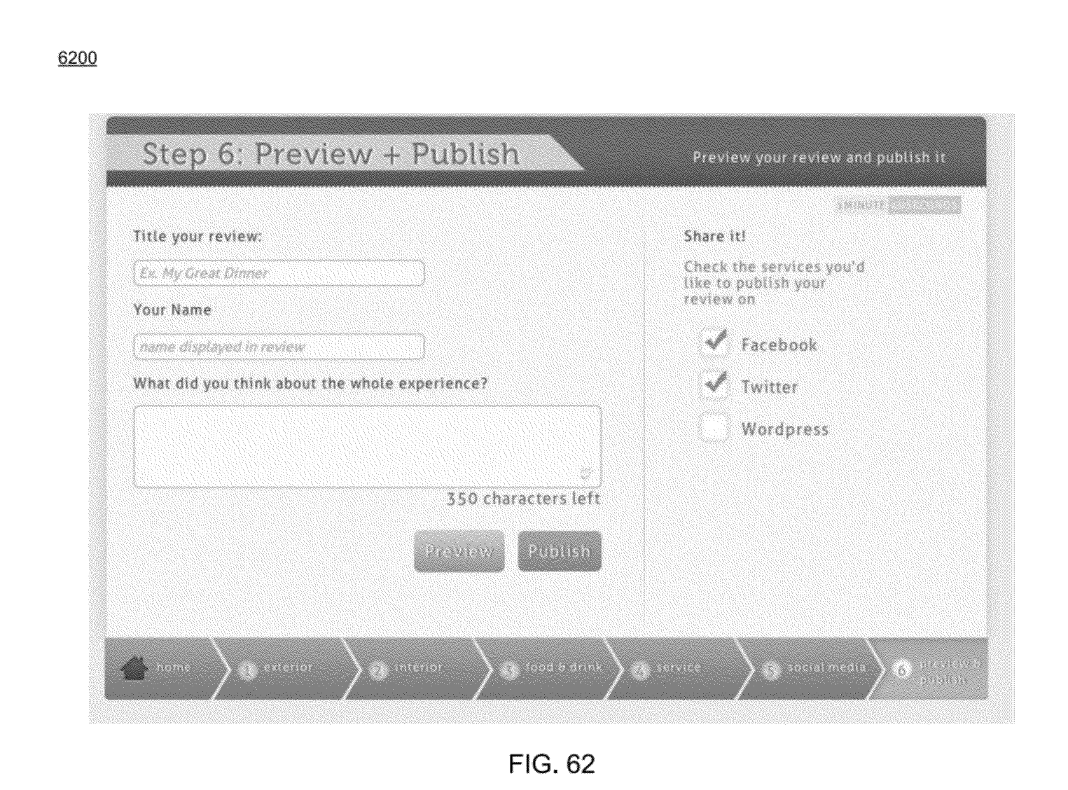

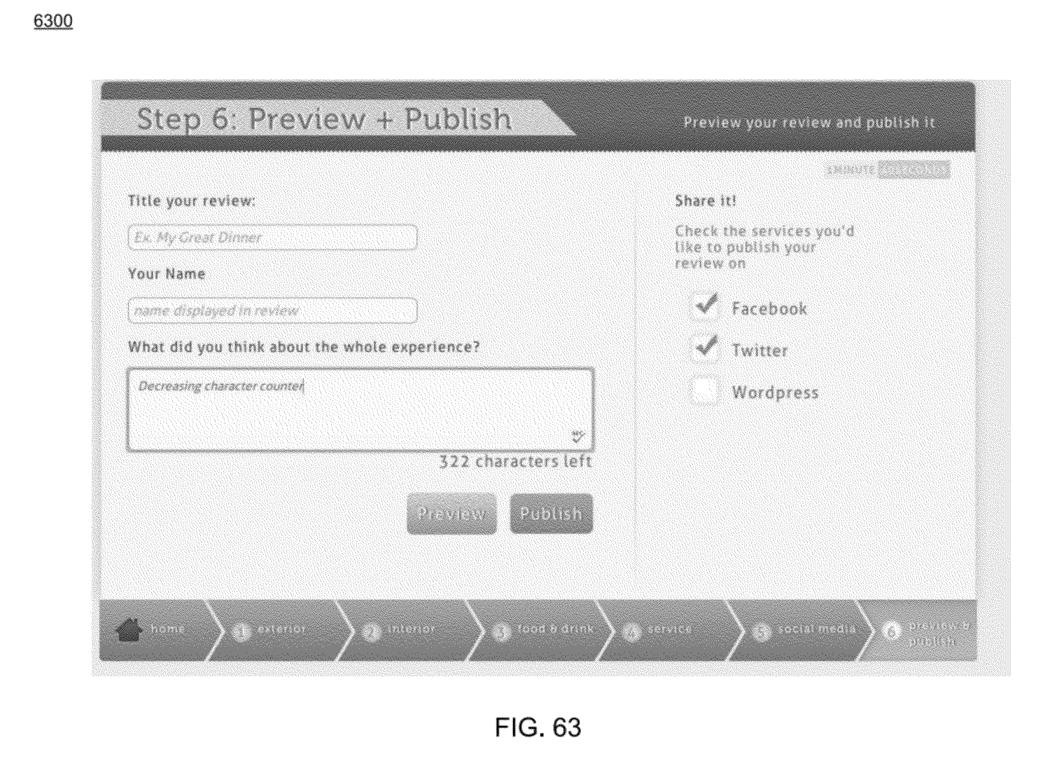

Referring now to FIGS. 36-63 embodiments showing various graphical user interfaces consistent with video generation process 10 is provided. Graphical user interfaces 3600-6300 show an example of video generation process 10 used in a restaurant critic environment. FIG. 36 depicts an exemplary initial log-in page associated with video generation process 10.

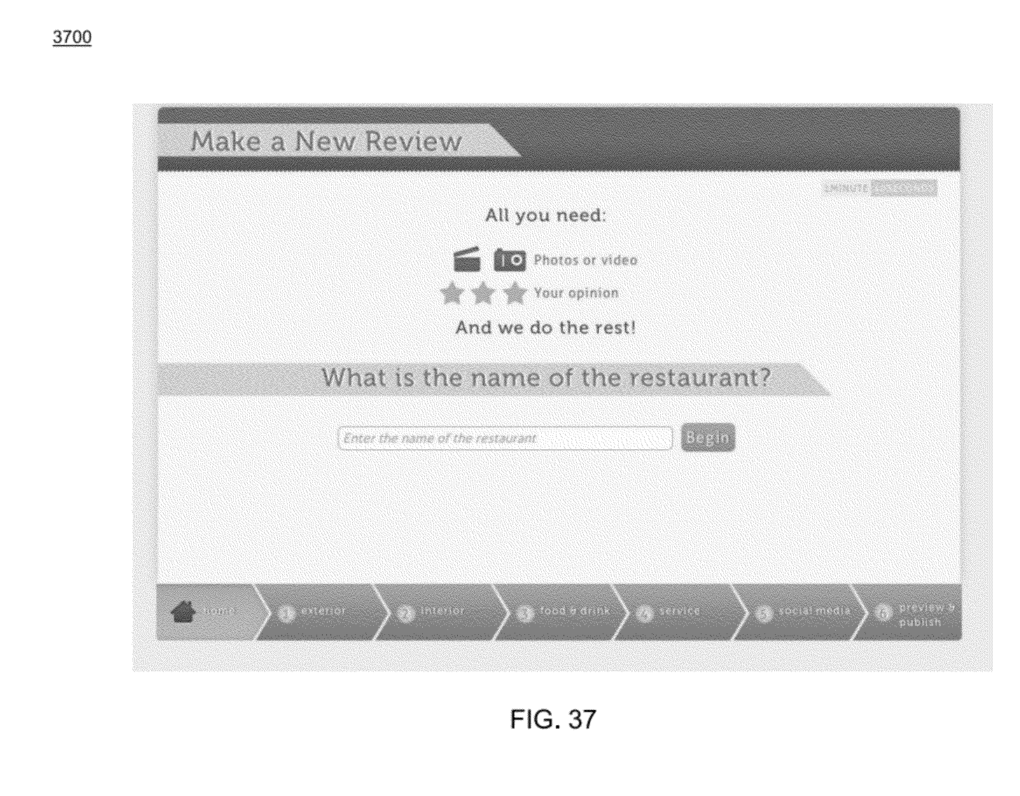

Referring now to FIGS. 37-40, a graphical user interface 3700 configured for the generation of a restaurant critique is provided. GUI 3700 may include options to edit one or more of a home page, exterior page, interior page, food and drink page, service page, social media page, and preview and publish page. As shown in FIG. 37, GUI 3700 may allow the user to enter the name of the restaurant to be reviewed.

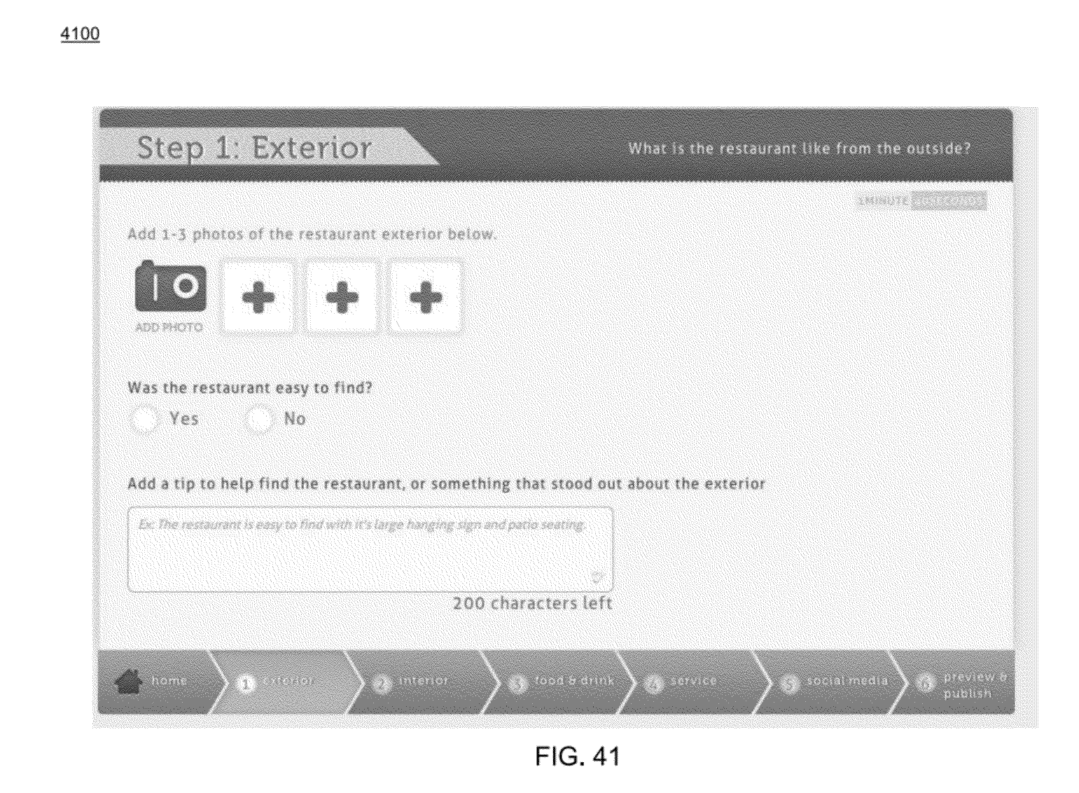

Referring now to FIGS. 41-44, a graphical user interface 4100 configured to allow a user to enter information pertaining to the exterior of the restaurant is provided. Exterior GUI 4100 may allow the user to upload photos, text, and video as is shown in FIGS. 41-44.

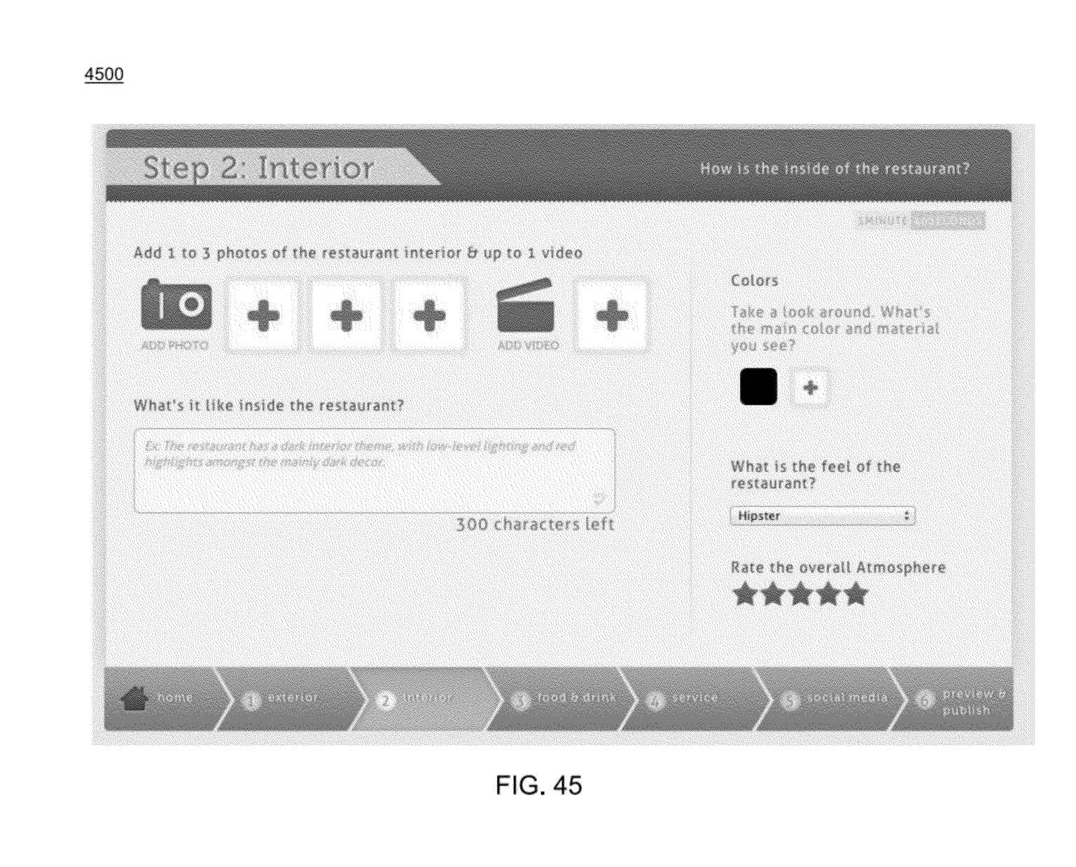

Referring now to FIGS. 45-50, a graphical user interface 4500 configured to allow a user to enter information pertaining to the interior of the restaurant is provided. Interior GUI 4500 may allow the user to upload photos, text, and video as is shown in FIGS. 45-50.

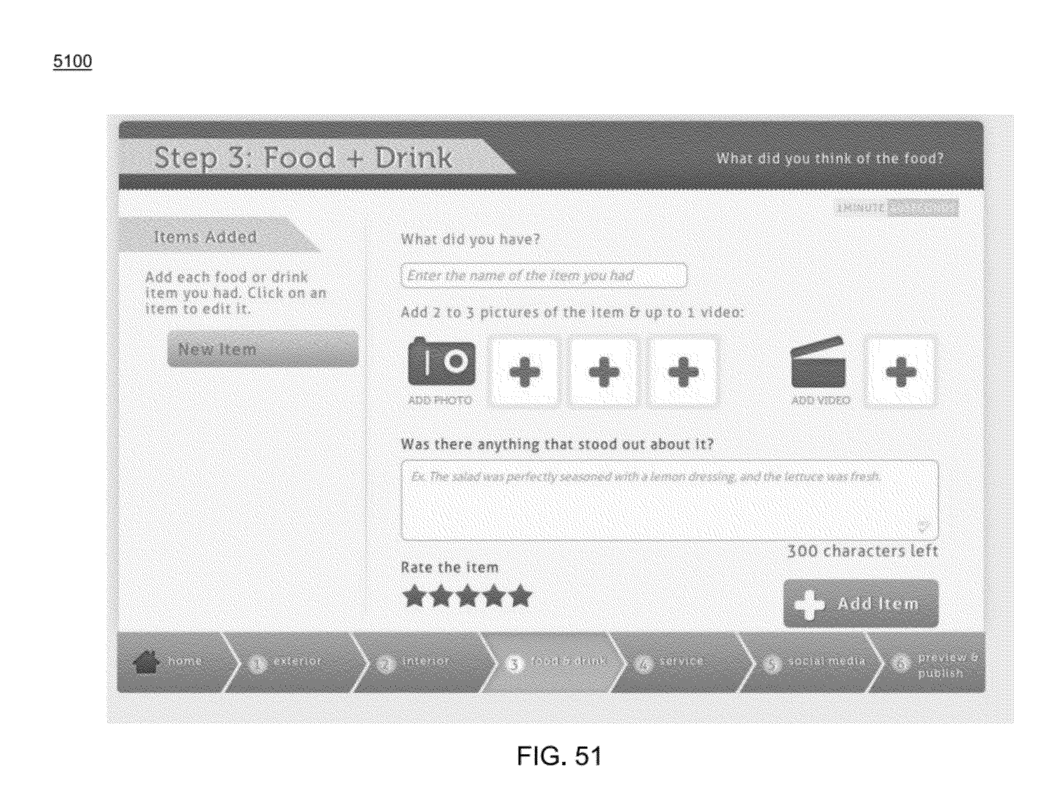

Referring now to FIGS. 51-54, a graphical user interface 5100 configured to allow a user to enter information pertaining to the food and drink of the restaurant is provided. Food and Drink GUI 5100 may allow the user to upload photos, text, and video as is shown in FIGS. 51-54.

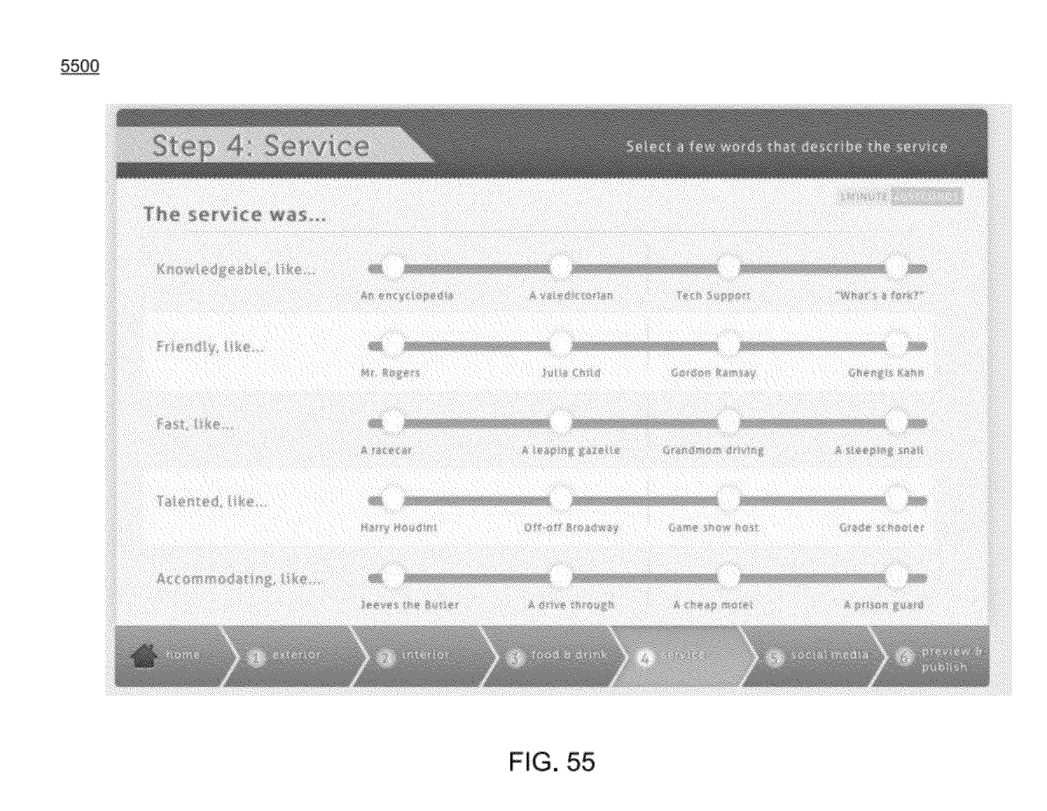

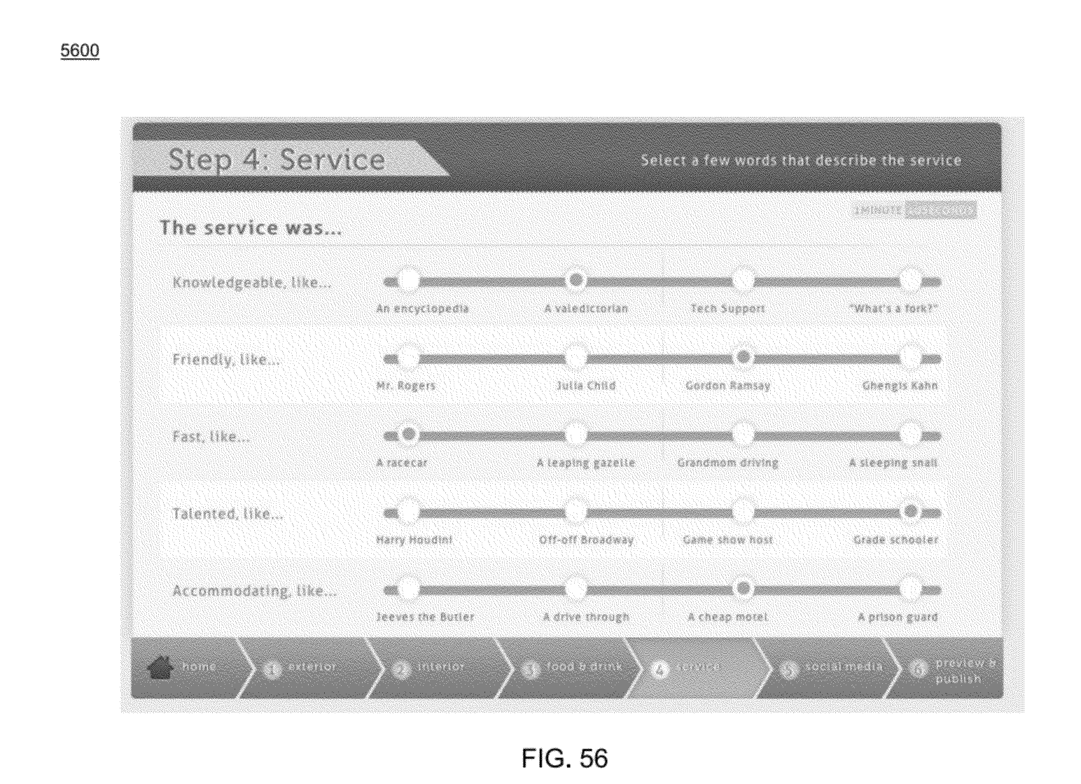

Referring now to FIGS. 55-56, a graphical user interface 5500 configured to allow a user to enter information pertaining to the service of the restaurant is provided. Service GUI 5100 may allow the user to upload photos, text, and video as is shown in FIGS. 55-56.

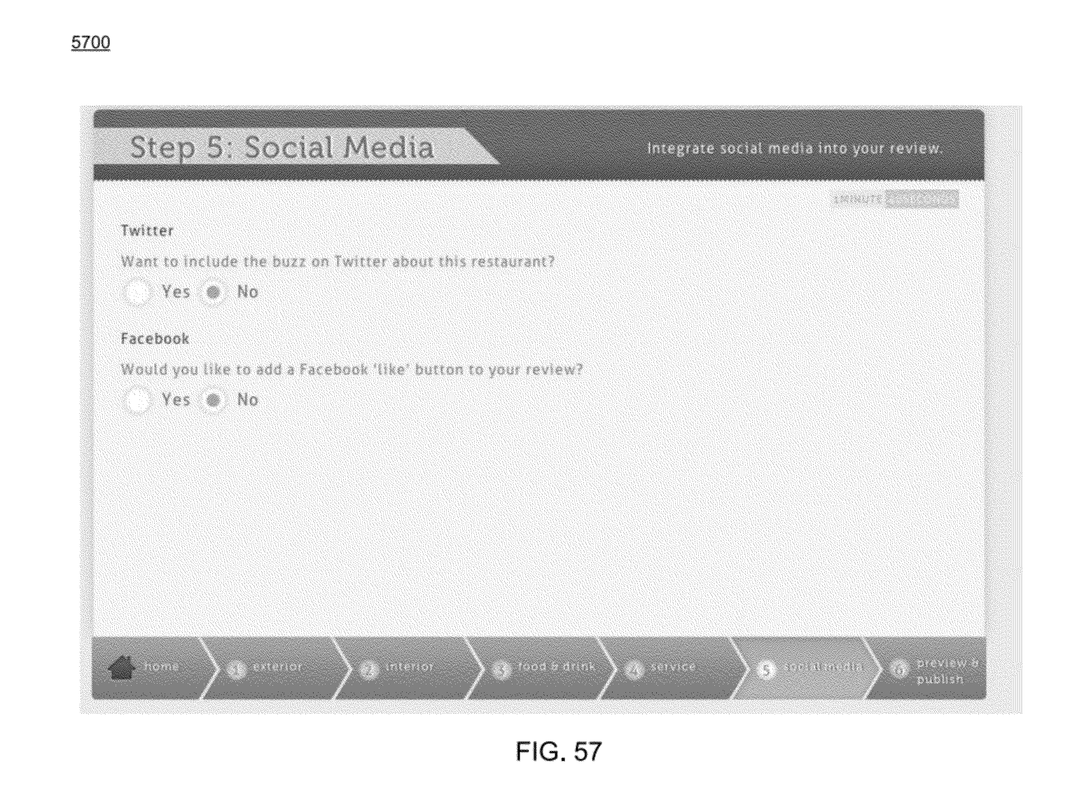

Referring now to FIGS. 57-60, a graphical user interface 5700 configured to allow a user to enter information pertaining to social media associated with the restaurant is provided. Social media GUI 5700 may allow the user to integrate social media into their review as is shown in FIGS. 57-60.

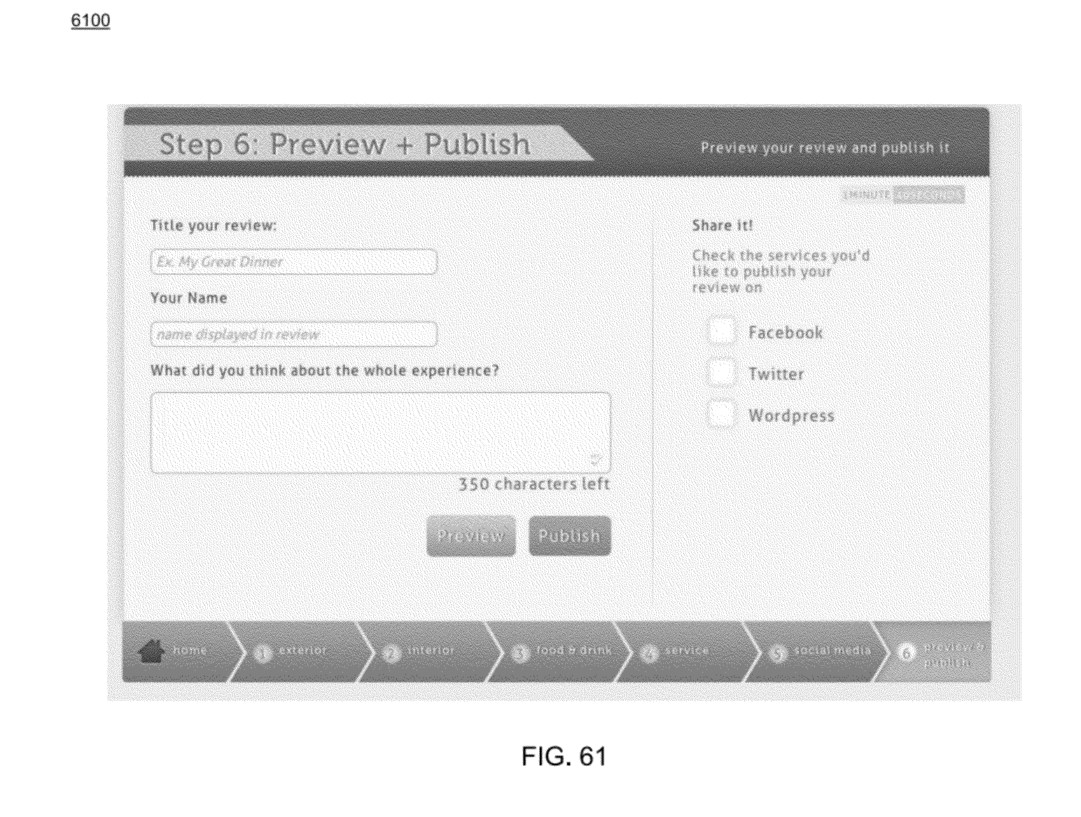

Referring now to FIGS. 61-63, a graphical user interface 6100 configured to allow a user to preview and/or publish the restaurant review is provided. Preview and Publish GUI 6100 may allow the user to preview the restaurant review as is shown in FIGS. 61-63.

As will be appreciated by one skilled in the art, aspects of the present invention may be embodied as a system, apparatus, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer (i.e., a client electronic device), partly on the user's computer, as a stand-alone software package, partly on the user's computer and partly on a remote computer or entirely on the remote computer or server (i.e., a server computer). In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described with reference to flowchart illustrations and/or block diagrams of methods, apparatus (systems) and/or computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures may illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Further, one or more blocks shown in the block diagrams and/or flowchart illustration may not be performed in some implementations or may not be required in some implementations. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

A number of embodiments and implementations have been described. Nevertheless, it will be understood that various modifications may be made. Accordingly, other embodiments and implementations are within the scope of the following claims.

What is claimed is:

1. A computer-implemented method for producing video presentations comprising:
providing, using one or more computing devices, a template configured to enable the generation of a video presentation;
receiving, using the one or more computing devices, an input parameter associated with the template from a user;
generating instructions, using the one or more computing devices, the instructions configured to enable the video presentation based upon, at least in part, the input parameter associated with the template; and
transmitting, using the one or more computing devices, the instructions associated with the video presentation to a video player configured to translate the video presentation to a web browser.

2. The computer-implemented method of claim 1, wherein the video presentation utilizes, at least in part, HTML5.

3. The computer-implemented method of claim 1, wherein the input parameter includes at least one of pre-recorded spoken audio, non-speech pre-recorded audio, text-to-speech audio, text, digital images, and digital video.

4. The computer-implemented method of claim 1, wherein the video presentation is at least one of an interactive video presentation and a non-interactive video presentation.

5. The computer-implemented method of claim 1, wherein the template is associated with at least one of the following areas, instructions for how to use a device, human-resources information, sales pitches, health care information, entertainment, financial services, corporate uses, and internet applications

6. The computer-implemented method of claim 1, wherein the template is a pre-defined template.

7. The computer-implemented method of claim 1, wherein the template is generated based upon, at least in part, preferences of the user.

8. The computer-implemented method of claim 1, wherein the template includes a scene editor configured to allow the user to configure one or more sections of the template.

9. The computer-implemented method of claim 1, wherein the instructions are configured to enable time-based animation.

10. The computer-implemented method of claim 1, wherein the instructions are generated by an engine that is indirectly coupled to the video player.

11. The computer-implemented method of claim 1, further comprising:
automatically altering video length based upon, at least in part, a length of text obtained from the Internet.

12. The computer-implemented method of claim 1, further comprising:
automatically expanding video length to match audio length in a scene associated with the video presentation.

13. The computer-implemented method of claim 1, wherein
automatically contracting video length to match audio length in a scene associated with the video presentation.

14. The computer-implemented method of claim 1, further comprising:
automatically expanding audio length to match video length in a scene associated with the video presentation.

15. The computer-implemented method of claim 1, further comprising:
automatically contracting audio length to match video length in a scene associated with the video presentation.

16. A computer program product residing on a computer readable storage medium having a plurality of instructions stored thereon, which, when executed by a processor, cause the processor to perform operations comprising:
providing, using one or more computing devices, a template configured to enable the generation of a video presentation;
receiving, using the one or more computing devices, an input parameter associated with the template from a user;
generating instructions, using the one or more computing devices, the instructions configured to enable the video presentation based upon, at least in part, the input parameter associated with the template; and
transmitting, using the one or more computing devices, the instructions associated with the video presentation to a video player configured to translate the video presentation to a web browser.

17. The computer program product of claim 16, wherein the video presentation utilizes, at least in part, HTML5.

18. The computer program product of claim 16, wherein the input parameter includes at least one of pre-recorded spoken audio, non-speech pre-recorded audio, text-to-speech audio, text, digital images, and digital video.

19. The computer program product of claim 16, wherein the video presentation is at least one of an interactive video presentation and a non-interactive video presentation.

20. The computer program product of claim 16, wherein the template is associated with at least one of the following areas, instructions for how to use a device, human-resources information, sales pitches, health care information, entertainment, financial services, corporate uses, and internet applications

21. The computer program product of claim 16, wherein the template is a pre-defined template.

22. The computer program product of claim 16, wherein the template is generated based upon, at least in part, preferences of the user.

23. The computer program product of claim 16, wherein the template includes a scene editor configured to allow the user to configure one or more sections of the template.

24. The computer program product of claim 16, wherein the instructions are configured to enable time-based animation.

25. The computer program product of claim 16, wherein the instructions are generated by an engine that is indirectly coupled to the video player.

26. The computer program product of claim 16, further comprising:
automatically altering video length based upon, at least in part, a length of text obtained from the Internet.

27. The computer program product of claim 16, wherein operations further comprise:
automatically expanding video length to match audio length in a scene associated with the video presentation.

28. The computer program product of claim 16, wherein
automatically contracting video length to match audio length in a scene associated with the video presentation.

29. The computer program product of claim 16, wherein operations further comprise:
automatically expanding audio length to match video length in a scene associated with the video presentation.

30. The computer program product of claim 16, wherein operations further comprise:
automatically contracting audio length to match video length in a scene associated with the video presentation.

31. A computing system comprising:
at least one processor;
at least one memory architecture coupled with the at least one processor;
a first software module executable by the at least one processor and the at least one memory architecture, wherein the first software module is configured to provide a template configured to enable the generation of a video presentation;
a second software module executable by the at least one processor and the at least one memory architecture, wherein the second software module is configured to receive an input parameter associated with the template from a user;
a third software module executable by the at least one processor and the at least one memory architecture, wherein the third software module is configured to generate instructions, the instructions configured to enable the video presentation based upon, at least in part, the input parameter associated with the template; and
a fourth software module executable by the at least one processor and the at least one memory architecture, wherein the fourth software module is configured to transmit the instructions associated with the video presentation to a video player configured to translate the video presentation to a web browser.

32. The computing system of claim 31, wherein the video presentation utilizes, at least in part, HTML5.

33. The computing system of claim 31, wherein the input parameter includes at least one of pre-recorded spoken audio, non-speech pre-recorded audio, text-to-speech audio, text, digital images, and digital video.

34. The computing system of claim 31, wherein the video presentation is at least one of an interactive video presentation and a non-interactive video presentation.

35. The computing system of claim 31, wherein the template is associated with at least one of the following areas, instructions for how to use a device, human-resources information, sales pitches, health care information, entertainment, financial services, corporate uses, and internet applications

36. The computing system of claim 31, wherein the template is a pre-defined template.

37. The computing system of claim 31, wherein the template is generated based upon, at least in part, preferences of the user.

38. The computing system of claim 31, wherein the template includes a scene editor configured to allow the user to configure one or more sections of the template.

39. The computing system of claim 31, wherein the instructions are configured to enable time-based animation.

40. The computing system of claim 31, wherein the instructions are generated by an engine that is indirectly coupled to the video player.

41. The computing system of claim 31, further comprising:
automatically altering video length based upon, at least in part, a length of text obtained from the Internet.

42. The computing system of claim 31, further comprising:
a fifth software module executable by the at least one processor and the at least one memory architecture, wherein the fifth software module is configured to automatically expand video length to match audio length in a scene associated with the video presentation.

43. The computing system of claim 31, wherein
a sixth software module executable by the at least one processor and the at least one memory architecture, wherein the sixth software module is configured to automatically contract video length to match audio length in a scene associated with the video presentation.

44. The computing system of claim 31, further comprising:
a seventh software module executable by the at least one processor and the at least one memory architecture, wherein the seventh software module is configured to automatically expand audio length to match video length in a scene associated with the video presentation.

45. The computing system of claim 31, further comprising:
a eighth software module executable by the at least one processor and the at least one memory architecture, wherein the eighth software module is configured to automatically contract audio length to match video length in a scene associated with the video presentation.
